(19) United States
(12) Patent Application Publication
(10) Pub. No.: US 2026/0145073 A1
(43) Pub. Date: May 28, 2026

(54) VIRTUAL CHARACTER ACTION DECISION-MAKING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Huan HU, Shenzhen (CN); Sze Yeung LIU, Shenzhen (CN); Ruochen LIU, Shenzhen (CN); Qiyang CAO, Shenzhen (CN)

(21) Appl. No.: 19/446,580

(22) Filed: Jan. 12, 2026

Related U.S. Application Data
(63) Continuation of application No. PCT/CN2024/106208, filed on Jul. 18, 2024.

(30) Foreign Application Priority Data
Sep. 15, 2023 (CN) 202311195505.3

(51) Int. Cl. A63F 13/58

(52) U.S. Cl. CPC A63F 13/58

(57) ABSTRACT

A virtual character action decision-making method includes: obtaining state information, the state information representing a game battle state of a game battle in which a first virtual character is involved; inputting the state information to an action decision-making model, to obtain n target sub-actions serially outputted by n action output heads in the action decision-making model, different action output heads corresponding to different action types, the n action output heads being serially connected based on a dependency relationship between the action types, and the dependency relationship representing a dependency restriction situation between sub-actions under different action types; and controlling the first virtual character to execute a target action formed by the n target sub-actions.

### CROSS-REFERENCES TO RELATED APPLICATIONS

This application is a continuation of PCT Application No. PCT/CN2024/106208, filed on Jul. 18, 2024, which claims priority to Chinese Patent Application No. 202311195505.3, filed on Sep. 15, 2023 and entitled “VIRTUAL CHARACTER ACTION DECISION-MAKING METHOD AND APPARATUS, DEVICE, AND STORAGE MEDIUM”, the entire contents of all of which are incorporated herein by reference.

### FIELD OF THE TECHNOLOGY

Embodiments of the present disclosure relate to the technical field of artificial intelligence, and in particular, to a virtual character action decision-making method and apparatus, a device, and a storage medium.

### BACKGROUND OF THE DISCLOSURE

Nowadays, in a process of planning a video game, behavior logic of a non-player character (Non-Player Character, NPC) is generally as consistent as possible with a behavior logic of a real player, so that the NPC in the game is highly anthropomorphic.

A behavior tree (behavior tree) structure is often configured for making a behavior logic decision on the NPC. The behavior tree is a tool for implementing a complex behavior of the NPC. When controlling the NPC to execute actions, a computer device traverses from a root node of the behavior tree according to an execution sequence until a termination state is reached. In a process of traversing the behavior tree, the computer device determines, based on state information (success, failure, or running) returned by different leaf nodes and based on a set rule, a next node for execution, thereby making a behavior logic decision on the NPC.

However, the behavior tree structure is an algorithm based on a rule. When the set rule is not changed, the NPC is excessively monotonous in a scene. If the NPC needs to be highly anthropomorphic, a complex rule needs to be preset, causing high manpower costs and poor adaptation to different map scenes.

### SUMMARY

Embodiments of the present disclosure provide a virtual character action decision-making method and apparatus, a device, and a storage medium. The following technical solutions are adopted.

According to an aspect, an embodiment of the present disclosure provides a virtual character action decision-making method, performed by a computer device. The method includes: obtaining state information, the state information representing a game battle state of a game battle in which a first virtual character is involved; inputting the state information to an action decision-making model, to obtain n target sub-actions serially outputted by n action output heads in the action decision-making model, different action output heads corresponding to different action types, the n action output heads being serially connected based on a dependency relationship between the action types, the dependency relationship representing a dependency restriction situation between sub-actions under different action types, and n being a positive integer; and controlling the first virtual character to execute a target action formed by the n target sub-actions.

According to another aspect, an embodiment of the present disclosure provides a computer device. The computer device includes a processor and a memory. The memory has at least one computer instruction stored therein. The at least one computer instruction is loaded and executed by the processor, to implement the virtual character action decision-making method described in the foregoing aspect.

According to another aspect, an embodiment of the present disclosure provides a non-transitory computer-readable storage medium. The computer-readable storage medium has at least one computer instruction stored therein. The at least one instruction is loaded and executed by a processor to implement the virtual character action decision-making method described in the foregoing aspect.

The technical solutions provided in the embodiments of the present disclosure produce at least the following beneficial effects.

In this embodiment of the present disclosure, an action decision is made based on state information by using an action decision-making model. Thus, a proper target action can be determined according to a current state. The action decision-making model includes n action output heads serially connected. The n action output heads are respectively configured for outputting different target sub-actions. The n action output heads are serially connected based on a dependency relationship between action types, so that during action decision-making, the dependency relationship between different actions can be considered. Additionally, in a process of serially outputting the n target sub-actions, the n target sub-actions are associated temporally and causally, thereby improving appropriateness of the target actions, and improving anthropomorphization of a virtual character.

### BRIEF DESCRIPTION OF THE DRAWINGS

FIG. 1 shows a structural block diagram of a computer system according to an exemplary embodiment of the present disclosure.

FIG. 2 shows a flowchart of a virtual character action decision-making method according to an exemplary embodiment of the present disclosure.

FIG. 3 shows a schematic diagram of a ray detection scheme according to an exemplary embodiment of the present disclosure.

FIG. 4 shows a schematic diagram of a two-dimensional depth map according to an exemplary embodiment of the present disclosure.

FIG. 5 shows a schematic diagram of a user interface of an application for providing a virtual environment according to an exemplary embodiment of the present disclosure.

FIG. 6 shows a flowchart of a process of determining a target action according to an exemplary embodiment of the present disclosure.

FIG. 7 shows a schematic diagram of an autoregression structure of n action output heads according to an exemplary embodiment of the present disclosure.

FIG. 8 shows a schematic diagram of performing action masking on parallel action output heads in the related art.

FIG. 9 shows a schematic diagram of impact on a moving state caused by superimposition of a moving direction and an orientation direction according to an exemplary embodiment of the present disclosure.

FIG. 10 shows a schematic diagram of visual situation sensing according to an exemplary embodiment of the present disclosure.

FIG. 11 shows a schematic diagram of determining an effective aiming range in a vertical direction according to an exemplary embodiment of the present disclosure.

FIG. 12 shows a schematic diagram of an effective aiming range in a horizontal direction according to an exemplary embodiment of the present disclosure.

FIG. 13 shows a schematic diagram of an action decision-making model according to an exemplary embodiment of the present disclosure.

FIG. 14 shows a flowchart of a training process of an action decision-making model according to an exemplary embodiment of the present disclosure.

FIG. 15 shows a schematic diagram of interaction between a client and a server for training an action decision-making model in a training process according to an exemplary embodiment of the present disclosure.

FIG. 16 shows a schematic diagram of a decision-making mode implementing an action decision-making request in application and training processes according to an exemplary embodiment of the present disclosure.

FIG. 17 shows a schematic diagram of a decision-making mode implementing an action decision-making request in an application process according to an exemplary embodiment of the present disclosure.

FIG. 18 shows a schematic structural diagram of a virtual character action decision-making apparatus according to an exemplary embodiment of the present disclosure.

FIG. 19 shows a schematic structural diagram of a computer device according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

First, terms involved in embodiments of the present disclosure are described.

Agent: Agent capable of sensing an environment by using a sensor and acting on the environment by using an executor. For each possible sensing sequence, the agent is required to select an action to execute. The action enables own performance to reach an expected maximum value when the action has an indication and an evidence provided by the sensing sequence. In the embodiments of the present disclosure, a virtual character is used as an agent to sense a virtual environment, obtain environment sensing information, and execute a target action determined by an action decision-making model.

Virtual Environment: Virtual environment displayed (or provided) when an application runs on a computer device. The virtual environment may be a simulated environment of a real world, or may be a semi-simulated and semi-fictional environment, or may be an entirely fictional environment. The virtual environment may be any one of a two-dimensional virtual environment, a 2.5-dimensional virtual environment, and a three-dimensional virtual environment. This is not limited in the present disclosure. The following embodiments are described by using an example in which the virtual environment is a three-dimensional virtual environment.

Virtual Character: Movable object in a virtual environment. The movable object may be a virtual character, a virtual animal, or a cartoon person. In some embodiments, when the virtual environment is a three-dimensional virtual environment, the virtual character may be a three-dimensional virtual model. Each virtual character has a shape and a volume in the three-dimensional virtual environment, and occupies a part of space in the three-dimensional virtual environment. In some embodiments, the virtual character is a three-dimensional character built based on a three-dimensional human skeleton technology. The virtual character may show different external images through different skins. In some implementations, the virtual character may alternatively be implemented through a 2.5-dimensional model or 2-dimensional model. This is not limited in the embodiments of the present disclosure.

In the related art, an action decision-making process of a virtual character is implemented by using a hierarchical behavior tree structure based on an artificial rule. Search and execution are performed starting from a root node, and an execution result indicating one of “success”, “failure”, and “running” is returned, thereby controlling a behavior of the virtual character.

However, the rules of the behavior tree remain unchanged. Making an action decision of the virtual character based on the behavior tree makes the virtual character behave in a fixed manner, and it is difficult to implement complex control on a behavior logic of the virtual character. Additionally, in a complex scene, the behavior tree needs to have a large number of rules, causing a large amount of labor costs to be consumed.

In addition, in the related art, a network model conforming to behaviors of human players may be trained in a supervised learning manner by imitating and learning control data generated by a real player controlling a virtual character.

However, map scenes are diversified, and not all map scenes have enough real players for data acquisition of a computer device. Therefore, training the action decision-making model in the supervised learning manner wastes a large amount of time and manpower costs, and a decision-making policy of the action decision-making model trained in the supervised learning manner is excessively fitted to a distribution of training data, making it difficult to implement effective action decision-making during actual deployment.

Therefore, an embodiment of the present disclosure provides a virtual character action decision-making method. State information is obtained, and a target sub-action is serially outputted on n action output heads based on the state information according to an action decision-making model completing enhanced training, so that the outputted target sub-action is highly appropriate and anthropomorphic.

A computer device in the present disclosure may be a desktop computer, a laptop computer, a mobile phone, a tablet, a desktop, an e-book reader, a moving picture experts group audio layer III (Moving Picture Experts Group Audio Layer III, MP3) player, a moving picture experts group audio layer IV (Moving Picture Experts Group Audio Layer IV, MP4) player, an intelligent voice interaction device, an intelligent household appliance, an in-vehicle terminal, or the like. An application supporting a virtual environment, for example, an application supporting a three-dimensional virtual environment, is installed and run in the computer device. The application may be any one of a virtual reality application, a three-dimensional map program, a third-person shooter (Third-Person Shooter, TPS) game, a first-person shooter (First-Person Shooter, FPS) game, and a multiplayer online battle arena (Multiplayer Online Battle Arena, MOBA) game. In some embodiments, the application may be a standalone application, such as a standalone 3D game program, or may be an online application. The following embodiment is described by using an application in a game as an example.

A game based on a virtual environment is typically constructed from one or more maps of game worlds. The virtual environment in the game simulates a real-world scene. A target virtual character may perform actions such as walking, running, jumping, shooting, fighting, driving, climbing, gliding, switching between virtual items, and using virtual items to attack other virtual characters in the virtual environment.

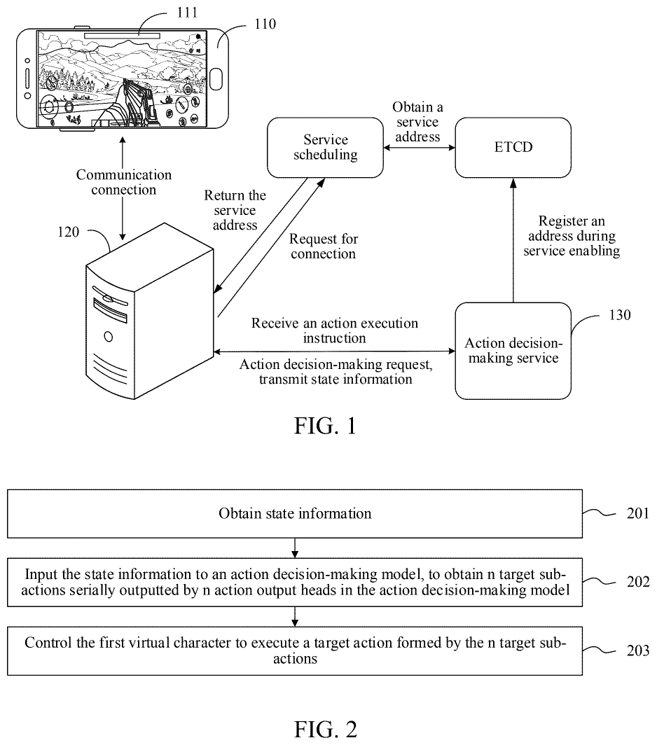

Refer to FIG. 1, which shows a structural block diagram of a computer system according to an exemplary embodiment of the present disclosure. The computer system may include a terminal 110, a first server 120, and a second server 130.

In this embodiment of the present disclosure, the terminal device 110 includes, but is not limited to, a mobile phone, a tablet, a laptop, a desktop, an e-book reader, an intelligent voice interaction device, an intelligent household appliance, an in-vehicle terminal, and the like. An application 111 supporting a virtual environment is run in the terminal 110. The application may be a third-person shooter (Third-Person Shooter, TPS) game or a first-person shooter (First-Person Shooter, FPS) game. When the application 111 is run in the terminal 110, a user interface of the application 111 is displayed on a screen of the terminal 110. A user controls, by using the terminal 110, a virtual character located in a virtual environment to perform an activity, or the terminal controls a non-player character (Non-Player Character, NPC) located in a virtual environment to perform an activity. The activities of the virtual character include, but are not limited to, at least one of adjusting a body posture, crawling, walking, running, riding, flying, jumping, driving, picking, shooting, attacking, throwing, and casting a skill.

The first server 120 includes at least one of one server, a plurality of servers, a cloud computing platform, and a virtualization center. In this embodiment of the present disclosure, the first server 120 is configured to provide a backend service for an application that supports a three-dimensional virtual environment, and may be a DS (Dedicated Server, dedicated server). In some embodiments, the first server 120 is in charge of primary computing works, and the terminal is in charge of secondary computing works. Alternatively, the first server 120 is in charge of secondary computing works, and the terminal is in charge of primary computing works. Alternatively, the first server 120 and the terminal perform collaborative computing by using a distributed computing architecture.

The second server 130 includes at least one of one server, a plurality of servers, a cloud computing platform, and a virtualization center. In this embodiment of the present disclosure, the second server 130 is configured to provide a virtual character action decision-making service for the application that supports the three-dimensional virtual environment. When the action decision-making service provided by the second server 130 is enabled, an address is registered in an ETCD (et-see-dee, distributed key-value store). In response to that there is a virtual character action decision-making requirement, the first server 120 requests a service scheduler for connection to a reasoning service, and obtains an address of an action decision-making service returned by the service scheduler. Thus, the first server 120 transmits, by using the obtained address, an action decision-making request to the action decision-making service provided by the second server 130. After the action decision-making service determines a target action based on a trained action decision-making model, an action instruction is returned to the first server 120.

In a process of training the action decision-making model, the second server 130 trains the action decision-making model based on state information transmitted by the first server 120 in a reinforcement learning manner.

This embodiment of the present disclosure may be applied to a navigation scene of a virtual character in a virtual environment, a scene in which a virtual action completes a specified task, or a game battle scene in which a virtual character and another virtual character are involved. This is not limited in this embodiment. The following provides an illustrative description of an application process of this embodiment of the present disclosure in a virtual scene.

A virtual character action decision-making method provided in an embodiment of the present disclosure is applied to a game scene. When an action decision on a first virtual character is to be made in the game scene, the terminal 110 or the first server 120 obtains state information of a game battle in which the first virtual character is involved, and n target sub-actions serially outputted by n action output heads are obtained based on the state information by using an action decision-making model trained by using the second server 130. In a training process, sample state information is obtained, and the sample state information is inputted to an action decision-making module, to train the action decision-making model.

This embodiment of the present disclosure may be further applied to various scenes such as cloud technology, artificial intelligence, intelligent transportation, and assisted driving. The foregoing implementation environment is merely used as an example, and does not limit an application scene of this embodiment of the present disclosure.

For ease of description, the following embodiments are described by using an example in which a virtual character action decision-making method in a virtual scene is performed by a computer device.

Refer to FIG. 2, which shows a flowchart of a virtual character action decision-making method according to an exemplary embodiment of the present disclosure. This embodiment is described by using an example in which the method is performed by a computer device. The method includes the following operations.

Operation 201: Obtain state information.

The state information represents a game battle state of a game battle in which a first virtual character is involved.

In some embodiments, the state information may include character state information of the first virtual character in the game battle, and environment sensing information of a virtual environment in which the first virtual character is located, and may further include other information that can represent a game battle state of a game scene. The character state information is a one-dimensional vector, and the environment sensing information is a two-dimensional image.

The character state information refers to information capable of reflecting a current state of the first virtual character, and may include current attribute information of the first virtual character, interaction information generated by interaction between the first virtual character and another virtual character (for representing an interaction state between the first virtual character and the another virtual character in a game), and interaction information of interaction between the first virtual character and an environment (for representing an interaction state between the first virtual character and the virtual environment in the game).

In a game scene, the computer device may use a game frame as a unit, and obtain current state information in a running process of each game frame. Alternatively, the computer device obtains current state information based on a particular period interval. A larger quantity of game frames included in each second indicates a smoother interface display. The quantity of game frames may be 36, and the computer device obtains 36 frames of state information per second. However, in response to that there is a relatively large quantity of frames, for example, when the quantity of frames is 72, a requirement on computer device performance is relatively high. In this case, a period may be set to 3. To be specific, one frame of state information is obtained every three game frames, and 24 frames of state information are obtained every second.

In one embodiment, the character state information is a one-dimensional vector, namely a vector feature. In a game scene, the character state information may be directly obtained from a game engine interface. In addition, a part of the character state information may alternatively be obtained in a ray detection manner.

By way of example, refer to Table 1, which shows classification of character state information provided by an exemplary embodiment of the present disclosure.

TABLE 1

| <<Attribute information>> | << Interaction information>> |
|---|---|
| <Shared by first/second | <Between first virtual character |
| virtual character> | and second virtual character> |
| Health point | Damaged or not |
| Position | Visible or not within a field of view |
| Orientation | Evade an attack or not |
| Quantity of current | Euclidean distance |
| virtual items | |
| Camp | Pathfinding distance |
| Attack or not | Relative coordinates based on |
| | orientation × distance of |
| | first virtual character |
| Crouch or not | Attack distance |
| Move or not | <Between first virtual character |
| | and cover> |
| Sprint or not | In a cover or not |
| Switch items or not | Is a cover safe? |
| Squat or not | Pathfinding distance |
| Jump or not | Euclidean distance |
| Lean or not | Relative coordinates of cover |
| Prone or not | <Between first virtual character |
| | and obstacle> |
| Aim down sights or not | Is a ray obscured? |
| Eliminate or not | Relative distance |

In some embodiments, the character state information includes a plurality of pieces of scalar information that can describe a current situation state, and may be state information of the first virtual character and information of interaction between the first virtual character and an environment. Essentially, the environment sensing information is obtained by the first virtual character sensing an ambient virtual environment, and describes relative features of the first virtual character relative to the virtual environment. Therefore, the relative features obtained by the action decision-making model are sufficiently diversified provided that the action decision-making model is trained in a sufficiently rich virtual environment, thereby ensuring that the action decision-making model has a capability of generalizing environment sensing.

However, the character state information may include some specific features that are strongly associated with a particular map scene, and therefore, the computer device performs further generalization processing based on the features.

In some embodiments, the computer device obtains relative state information by performing generalized processing on absolute state information included in the character state information. The relative state information is state information of the first virtual character relative to a second virtual character or an obstacle.

Specifically, general processing may be implemented in a manner of replacing absolute information with relative information. For example, absolute position information or absolute position orientations such as the first virtual character, the second virtual character, and a cover point are replaced with relative positions, namely position orientations, between the first virtual character and the second virtual character or between the first virtual character and the cover point or the obstacle.

The character state information includes interaction information between the first virtual character and the virtual environment, and the interaction information may be obtained in a ray detection manner.

In some embodiments, an environment sensing ray is transmitted to surroundings by using the position of the first virtual character as a start point. In response to that the environment sensing ray collides with a surface of the obstacle, the environment sensing ray is reflected along a normal direction of the environment sensing ray. Further, the computer device may obtain a reflection situation of the environment sensing ray, to determine the character state information of interaction between the first virtual character and the virtual environment, for example, interaction information between the first virtual character and the cover and interaction information between the first virtual character and the obstacle in Table 1.

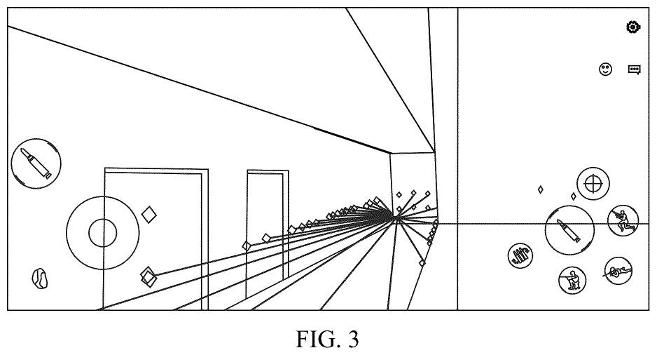

By way of example, FIG. 3 shows a schematic diagram of a ray detection scheme according to an exemplary embodiment of the present disclosure. The computer device transmits an environment sensing ray to surroundings by using a waist of a first virtual character as a start point, and the environment sensing ray is reflected in response to that the environment sensing ray collides with an obstacle in a virtual environment, to obtain interaction information between the first virtual character and the obstacle according to a reflection situation of the environment sensing ray.

In some embodiments, to obtain the interaction information between the first virtual character and the obstacle more accurately, the computer device transmits the environment sensing ray to the surroundings by using at least two heights of a position of the first virtual character as start points. Additionally, the interaction information between the first virtual character and the obstacle is generated according to the reflection situation of the environment sensing ray.

Transmission directions of different environment sensing rays transmitted at a same height are at a same horizontal height. For example, an environment sensing ray (i.e., an annular ray) is transmitted to the surroundings by using the foot, the waist, and the head of the position of the first virtual character as a start point, to obtain the interaction information between the first virtual character and the obstacle.

In one embodiment, a same quantity of environment sensing rays are transmitted by using different heights as start points. To be specific, a same quantity of annular rays are included on each layer. Reflection situations of annular rays at different heights can represent distances between the obstacle and the first virtual character in the virtual environment at different heights. A larger quantity of annular rays in each layer indicates a finer sensing of the obstacle around the first virtual character, and a higher requirement on the performance of the computer device.

In some embodiments, the environment sensing information in the game battle is a two-dimensional depth map of an orientation direction of the first virtual character. The two-dimensional depth map represents a depth situation of an obstacle in the orientation direction of the first virtual character.

In one embodiment, the computer device obtains the environment sensing information by means of ray detection based on the position of the first virtual character in the virtual environment and the orientation of the first virtual character.

Specifically, the environment sensing ray is transmitted to the orientation direction of the first virtual character by using the first virtual character as a start point. In response to that the environment sensing ray collides with the surface of the obstacle, the environment sensing ray is reflected along a normal direction of the environment sensing ray, so that the computer device can generate the environment sensing information according to the reflection situation of the environment sensing ray.

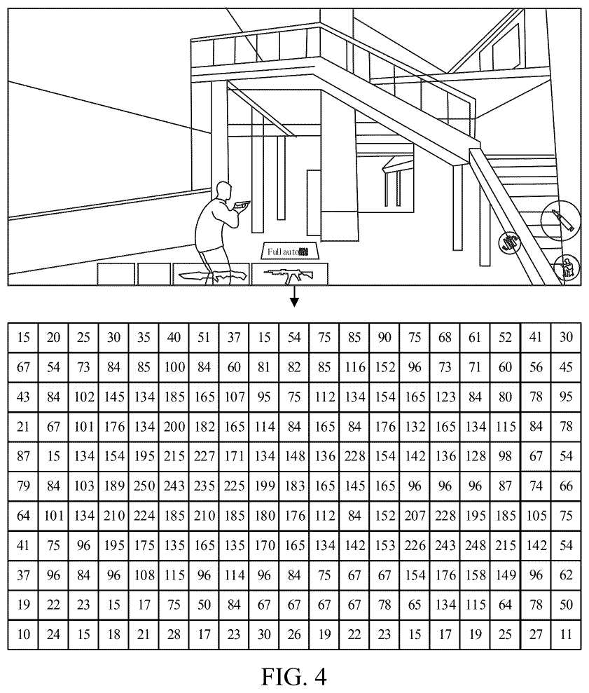

By way of example, refer to FIG. 4, which shows a schematic diagram of a two-dimensional depth map according to an exemplary embodiment of the present disclosure. A schematic diagram of a virtual environment corresponds to the two-dimensional depth map. A number in each grid represents a grayscale value of the region in an image. The grayscale value ranges from 0 to 255, where white is 255, and black is 0. A smaller grayscale value indicates a darker color of a pixel in the image region. Environment sensing information is a two-dimensional depth map in an orientation direction of a first virtual character. A darker color of a pixel in the depth map indicates a smaller distance between an obstacle corresponding to the pixel and the first virtual character. A lighter color of a pixel in the depth map indicates a larger distance between an obstacle corresponding to the pixel and the first virtual character.

In some embodiments, the fineness of the virtual environment represented by the two-dimensional depth map is in a positive correlation with resolution. A larger sampling resolution of the two-dimensional depth map indicates finer depth information of an obstacle in front of the first virtual character represented by the two-dimensional depth map.

Operation 202: Input the state information to an action decision-making model, to obtain n target sub-actions serially outputted by n action output heads in the action decision-making model.

Different action output heads correspond to different action types, and the n action output heads are serially connected based on a dependency relationship between the action types. The dependency relationship represents a dependency restriction situation between sub-actions under different action types, where n is a positive integer.

In the action decision-making model, the n action output heads belong to output layers of the action decision-making model, and are configured for predicting actions in different dimensions, so as to output action parameters in different dimensions. Action dimensions supported to be executed by the first virtual character may include a moving state dimension, a moving direction dimension, an orientation dimension, an attack dimension, a posture dimension, and the like. In the action decision-making model, n action output heads respectively correspond to n action dimensions, and the n action output heads output action parameters in n different dimensions. For example, an action parameter outputted by an action output head corresponding to the moving direction dimension is a specific moving direction, for example, a 90° direction. An action parameter outputted by an action output head corresponding to the orientation dimension is a turning angle that can represent a direction, for example, −5°, representing rotating by 5° in an anticlockwise direction. An action parameter outputted by an action output head corresponding to the attack dimension is attack or not, and so on. Specific action dimension division and action parameters outputted by action output heads corresponding to different action dimensions are not limited in this embodiment.

In some embodiments, the computer device decomposes executable actions of the first virtual character orthogonally, to obtain n action types. Different action types include at least two executable actions. In some embodiments, the n action types include at least two executable sub-actions, and sub-actions in different action types may be controlled independently. In some embodiments, sub-actions in a same action type cannot be controlled or executed simultaneously; to be specific, the first virtual character may be controlled to execute only a sub-action in one action type.

The orthogonal decomposition is configured for dividing the executable actions of the first virtual character into a plurality of discretized action types. The n action types obtained after the orthogonal decomposition are orthogonal action types of each other. Sub-actions in different orthogonal action types do not have an intersection set. To be specific, there is no sub-action belonging to two action types. Different orthogonal action types support being executed simultaneously, and different sub-actions in a same orthogonal action type do not support being executed simultaneously.

In a game scene, a most basic and finest atomic action for controlling the first virtual character exists, and this type of action cannot be further divided and refined. A sub-action in one action type is an atomic action, and different sub-actions in the same action type cannot be simultaneously executed. For example, if the executable actions of the first virtual character include an action of creeping and moving forward, the action may be divided into two atomic actions: “creeping” and “moving forward”, where “creeping” corresponds to a posture action type, and “moving forward” corresponds to a moving direction action type. For another example, if the executable actions of the first virtual character include an action of peeking and shooting while stationary, the action may be classified into three atomic actions: “stationary”, “peeking”, and “shooting”, where “stationary” corresponds to a moving state action type, “peeking” corresponds to a peeking action type, and “shooting” corresponds to an attack action type.

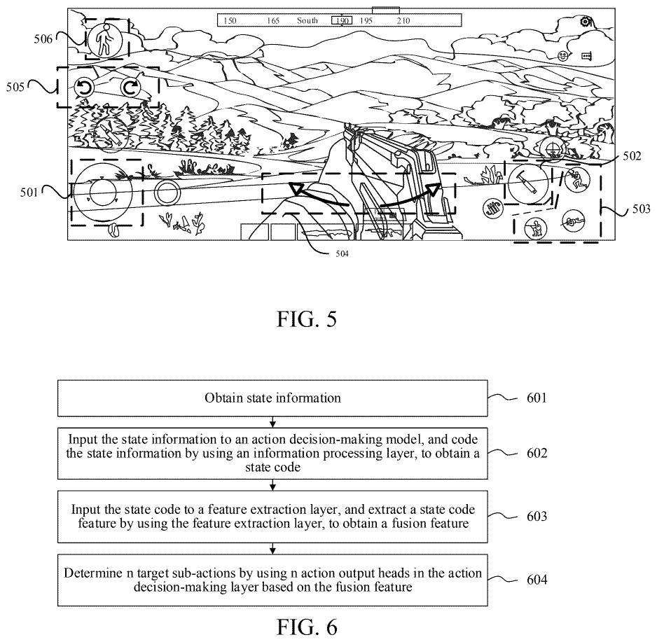

By way of example, refer to FIG. 5, which shows a schematic diagram of a user interface of an application for providing a virtual environment according to an exemplary embodiment of the present disclosure. A moving state control 501, an attack control 502, a posture adjustment control 503, a horizontal turning control, a vertical turning control 504, a left-right peeking control 505, and a moving state control 506 are included. Different controls may trigger to control a virtual character to execute different actions.

Actions corresponding to the controls shown in the foregoing figure are decomposed orthogonally, to obtain a plurality of action types.

In some embodiments, there may be a dependency relationship between different action types. For example, only when performing an attack operation, a virtual character stands or leans, posture action decision-making of the first virtual character needs to depend on action decision-making of an attack action type. Additionally, the dependency restriction situation indicates that a dependency restriction relationship may exist between sub-actions of different action types. For example, when the first virtual character performs a sprinting action and does not support executing an attack action at the same time, a dependency restriction relationship exists between the sprinting action and the attack action. Therefore, to enable the action decision-making model to consider a dependency relationship between different actions and a dependency restriction situation between different sub-actions in different action types during action decision-making, the computer device serially connects the n action output heads in the action decision-making layer based on the dependency relationship between the action types.

In some embodiments, when determining a connection sequence of different action output heads, the computer device may determine the connection sequence of the action output heads according to degrees of association of different action types with respect to a task to be completed by the first virtual character. For example, if a task of the first virtual character is defeating an enemy, it may be determined that a degree of association between the task and an attack action type is relatively high, and a corresponding action output head may be ranked at a top position. However, a degree of association between the task and a leaning action type is apparently low, and an action output head corresponding to the leaning action type may be ranked at the bottom.

Operation 203: Control the first virtual character to execute a target action formed by the n target sub-actions.

In some embodiments, the action decision-making model is deployed in a second server. In response to that a target action is determined by using the action decision-making model, the second server transmits an action execution instruction to a first server for supporting an application of a virtual environment to provide a backend service. Then, the first server transmits the action execution instruction to a client, to control execution of an action by the first virtual character.

In one embodiment, the computer device separately codes sub-action names in different action types, to obtain a plurality of candidate action tags. The computer device obtains, based on the action decision-making layer in the action decision-making model, a probability distribution of the sub-actions in the action types, and determines, based on an action execution probability, a target sub-action tag in sub-action tags. In response to that the target sub-action tag is determined, the computer device decodes the target sub-action tag, to obtain a target sub-action, and controls the first virtual character to execute a target action formed by a plurality of target sub-actions.

In conclusion, in this embodiment of the present disclosure, an action decision is made based on state information by using an action decision-making model. Thus, a proper target action can be determined according to a current state. The action decision-making model includes n action output heads serially connected. The n action output heads are respectively configured for outputting different target sub-actions. The n action output heads are serially connected based on a dependency relationship between action types, so that during action decision-making, the dependency relationship between different actions can be considered. Additionally, in a process of serially outputting the n target sub-actions, the n target sub-actions are associated temporally and causally, thereby improving appropriateness of the target actions, and improving anthropomorphization of a virtual character.

In this embodiment of the present disclosure, the action decision-making model includes an information processing layer, a feature extraction layer, and an action decision-making layer. The action decision-making layer includes the n action output heads. The process of determining n target sub-actions is described below by using an exemplary embodiment.

Refer to FIG. 6, which shows a flowchart of a process of determining a target action according to an exemplary embodiment of the present disclosure.

Operation 601: Obtain state information.

For an implementation of this operation, refer to the foregoing operation 201.

Details are not described in this embodiment again.

Operation 602: Input the state information to an action decision-making model, and code the state information by using an information processing layer, to obtain a state code.

In some embodiments, the state information includes character state information of a first virtual character in a game battle, and environment sensing information of a virtual environment in which the first virtual character is located. The character state information represents an interaction state between the first virtual character and a second virtual character in the game battle and an interaction state between the first virtual character and the virtual environment in the game battle. The character state information is a one-dimensional vector. The environment sensing information is a two-dimensional image. In some embodiments, the computer device codes the character state information and the environment sensing information included in the state information in different coding manners by using the information processing layer.

In some embodiments, the information processing layer includes a scalar coder and an image coder. The computer device inputs the state information to the action decision-making model, and codes the character state information by using the scalar coder in the information processing layer, to obtain a state information coding result. The environment sensing information is coded by using the image coder in the information processing layer, to obtain an environment information coding result. Finally, the state information coding result and the environment information coding result are concatenated by using the information processing layer, to obtain the state code.

In some embodiments, the scalar coder includes a one-dimensional convolution kernel. The computer device performs one-dimensional convolution processing on attribute information and interaction information in the character state information by using the one-dimensional convolution kernel, to obtain a state information coding result.

In some embodiments, the image coder includes a two-dimensional convolution kernel. The computer device codes the environment sensing information in the state information by using the two-dimensional convolution kernel, to obtain an environment information coding result. The two-dimensional convolution kernel is a two-dimensional matrix. In a process of coding a two-dimensional depth map by using the two-dimensional convolution kernel, the two-dimensional matrix and the input two-dimensional depth map are multiplied and summed element by element, to complete feature coding of the environment sensing information.

After obtaining the state information coding result and the environment information coding result, the computer device concatenates the state information coding result and the sensing information coding result by using a fully connected layer and an activation function, to obtain a state code. The fully connected layer is configured for mapping a feature space obtained by convolution calculation of a previous layer to a sample marking space (to be specific, feature representations are integrated into one value), so that impact of a feature position on a classification result can be reduced, and the robustness of the action decision-making model can be improved. The activation function is configured for adding a non-linear factor, thereby improving an expression capability of the action decision-making model.

Operation 603: Input the state code to a feature extraction layer, and extract a state code feature by using the feature extraction layer, to obtain a fusion feature.

In one embodiment, the information processing layer further includes an LSTM (Long Short Term Memory, long short term memory) network. The computer device inputs the state code to the LSTM network, and obtains the fusion feature through feature extraction. During the feature extraction, the long short term memory network retains features with more important values, and forgets features with lower values, thereby implementing the feature extraction.

In some embodiments, the LSTM network may be replaced with another convolutional neural network. This is not limited in this embodiment.

Operation 604: Determine n target sub-actions by using n action output heads in the action decision-making layer based on the fusion feature.

In some embodiments, the computer device inputs the fusion feature to the action decision-making layer, and because n action output heads in the action decision-making layer are serially connected, inputting the fusion feature to the action decision-making layer is first inputting the fusion feature to a first action output head of the action decision-making layer, and determining a first target sub-action from sub-actions of a first action type by using the first action output head in the action decision-making layer.

In some embodiments, the action decision-making model further includes an information filtering layer. The information filtering layer is connected to an output end of the scalar coder, and the information filtering layer is connected to an input end of the action decision-making layer. The computer device filters the character state information by using the information filtering layer in response to that the character state information is obtained, to obtain filtered character state information. The filtered character state information has a correlation relationship with a first action type corresponding to a first action output head. Further, the computer device inputs the filtered character state information to the first action output head. Additionally, because the first action output head is most associated with a to-be-completed task, the character state information having the highest correlation with the first action type and the fusion feature are both inputted to the action decision-making layer, thereby facilitating enhancement of an appropriate decision-making capability of the first action output head.

By way of example, Table 2 shows a correspondence relationship between an action output head and an action type after orthogonal decomposition according to an exemplary embodiment of the present disclosure.

TABLE 2

| | Action dimension | |
|---|---|---|
| | (including number | |
| Action output head name | of sub-actions) | Action type |
| First action output head | 2 | Attack or not |
| Second action output head | 4 | Posture |
| Third action output head | 8 | Moving direction |
| Fourth action output head | 8 | Horizontal orientation |
| Fifth action output head | 8 | Vertical orientation |
| Sixth action output head | 3 | Peek or not |
| Seventh action output | 4 | Moving posture |
| head | | |

In one embodiment, different action output heads are serially connected. Therefore, after inputting the fusion feature to the first action output head in the action decision-making layer, and determining the first target sub-action from the first action type by using the first action output head, the computer device further needs to input embedding coded vectors respectively corresponding to the determined first target sub-action to an (i−1)^{th} target sub-action and the fusion feature to the action decision-making layer, and determines an i^{th} target sub-action from an i^{th} action type by using an i^{th} action output head in the action decision-making layer.

The first target sub-action to the (i−1)^{th} target sub-action are respectively determined by the first action output head to an (i−1)^{th} action output head, where i is less than or equal to n, and i is greater than 1.

In some embodiments, the n action output heads are connected by using an autoregression embedding layer. Because there is a dependency relationship between different action types, after a previous output head determines the target sub-action, at least one determined target sub-action and the fusion feature are to be inputted to a subsequent action output head based on an autoregression embedding layer, so that the subsequent action output head determines the target sub-action according to the dependency relationship.

The autoregression refers to a method of processing a time sequence in statistics. Moments previous to a same variable are used for predicting representation of the variable at a current moment. The autoregression has time sequence autocorrelation. The essence of embedding (embedding) is data compression, and a feature of a relatively high dimension that has redundant information is expressed by using a feature of a relatively low dimension.

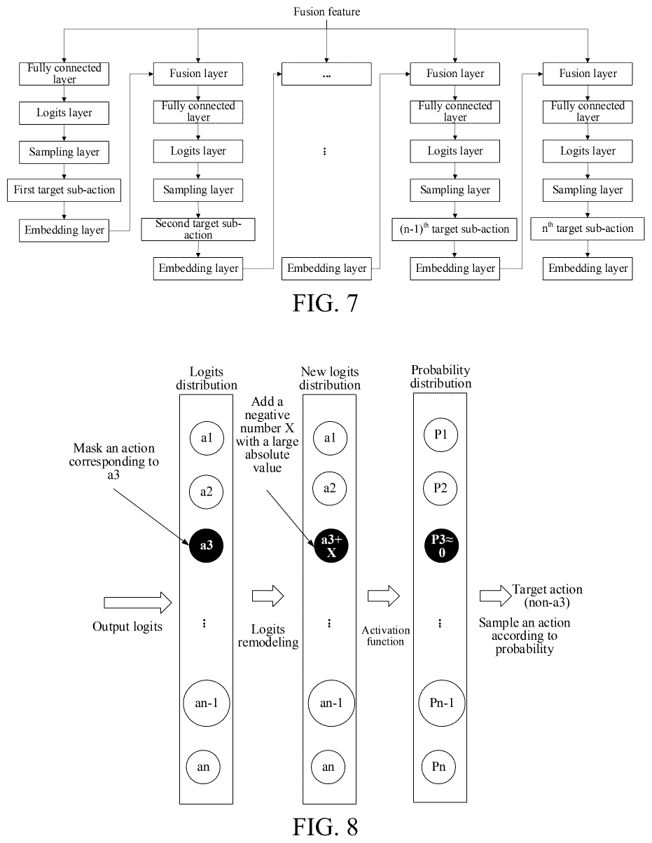

Refer to FIG. 7, which shows a schematic diagram of an autoregression structure of n action output heads according to an exemplary embodiment of the present disclosure. An action output head includes a fully connected layer, a Logits layer, a sampling layer, and an embedding layer. The Logits layer is an execution probability distribution between sub-actions in a determined action type, so as to determine a target sub-action. After the target sub-action is determined, the determined sub-action is transmitted to a next serially connected action output head by using the embedding layer. The action output head integrates the target sub-actions that have been determined previously, so as to determine a new target sub-action according to the determined target sub-action. In addition, the information processing layer may input the fusion feature to each action output head.

In this embodiment of the present disclosure, the action control is discretized through orthogonal decomposition, to reduce a dimension of the action control, and n target sub-actions are serially determined based on the n action output heads in the action decision-making model, so that the action control can be discretized through orthogonal decomposition, thereby effectively decoupling a structured action space. Additionally, serial action output heads are combined to improve appropriateness of the action decision-making model and improve training efficiency in a model training process.

In some embodiments, in a process of serially outputting n target sub-actions by using n action output heads, considering that a dependency restriction relationship exists between sub-actions in different action types, to block an inappropriate sub-action in different action types, or a sub-action that has a dependency restriction relationship with a determined target sub-action, the computer device may further set an action masking layer in the action decision-making model, and mask sub-actions in different action types by using the action masking layer.

Essentially, action masking is configured for screening out inappropriate sub-actions in different action types or sub-actions that have a dependency restriction relationship with the determined target sub-action. The probability of the masked sub-action in the probability distribution obtained by the action output head is reduced by means of action masking. Thus, when the target sub-action is determined according to probability sampling, the masked sub-action cannot be determined as the target sub-action. By means of action masking, a sub-action branch that is not necessarily explored can be directly excluded from the action decision-making process, thereby reducing the action space, and improving exploration efficiency of the action decision-making model and ensuring output accuracy of the action decision-making model.

At least two sub-actions that have a dependency restriction relationship belong to different action types, and the at least two sub-actions that have a dependency restriction relationship cannot be executed simultaneously. In some embodiments, if a dependency restriction relationship exists between a first sub-action and a second sub-action, the two sub-actions cannot be simultaneously executed. Therefore, if it is determined that the first sub-action is a target sub-action, action masking needs to be performed on the second sub-action. In some embodiments, after the second sub-action is combined with a third sub-action, there is a dependency restriction relationship with a fourth sub-action, so that a combination of the second sub-action and the third sub-action and the fourth sub-action cannot be simultaneously performed. Therefore, if it is determined that both the second sub-action and the third sub-action are target sub-actions, action masking needs to be performed on the fourth sub-action.

In the related art, in a process of applying action masking to parallel action output heads, the action output heads output sub-actions in parallel, the action output heads are connected in parallel, and each action output head outputs a different sub-action instruction. For an action output head to be action-masked, a probability that an output action is selected approaches to 0.

Refer to FIG. 8, which shows a schematic diagram of performing action masking on parallel action output heads in the related art. During action masking, on an original logits action output layer of a network, a negative number with a very large absolute value is added to logits of an inappropriate action, to ensure that a logits value corresponding to the action is less than logits values of all appropriate actions, thereby remolding a logits distribution of the output action layer, and mapping a probability that the inappropriate action is sampled to be close to zero. In the figure, a1 to an+1 represent logits distributions of different actions, and P1 to Pn+1 represent sampling probabilities corresponding to the actions. When i=3 in the figure, action masking is performed on an action corresponding to a3, and a negative number with a very large absolute value is added to obtain a new logits distribution. When sampling is performed again according to the probability, it is difficult to sample an action corresponding to a3.

In some embodiments, because sub-actions of different action types have a dependency restriction relationship, and at least two sub-actions having the dependency restriction relationship do not support being executed simultaneously, in response to that a determined previous target sub-action exists, there may be a dependency restriction relationship between some sub-actions in subsequent action types and the determined target sub-action. Additionally, because an action space dimension obtained after orthogonal decomposition is still very high, abundant anthropomorphic atomic action space combinations explode. Therefore, the sub-actions may be determined according to appropriateness (i.e., the dependency restriction relationship) of combinations of different sub-actions, thereby improving the anthropomorphization of the action combination. In addition, in a process of training the action decision-making model, an action masking manner may be configured for reducing ineffective exploration of a decision-making policy on the action decision-making layer, to accelerate training efficiency and improve anthropomorphic action decision-making of the action decision-making model.

The action masking may be configured for a reinforcement learning model (corresponding to the action decision-making model in this embodiment of the present disclosure), and may block an inappropriate or invalid action set in a large-scale decision-making space, thereby reducing meaningless action exploration, and enabling the action decision-making layer to converge more quickly.

In some embodiments, the action decision-making model includes an action masking layer. The action masking layer is connected to the n action output heads in the action decision-making layer, and is configured for performing action masking on a sub-action in each action type in an action decision-making process of each output head.

In one embodiment, the computer device performs action masking on a sub-action in an i^{th} action type based on the determined first target sub-action to an (i−1)^{th} target sub-action and a dependency restriction relationship indicated by the dependency restriction situation between sub-actions under different action types. At least two sub-actions having the dependency restriction relationship are not supported to be executed simultaneously. Thus, the computer device determines, by using the i^{th} action output head in the action decision-making layer, the i^{th} target sub-action from sub-actions not masked in the i^{th} action type.

In some embodiments, before the action masking is performed, the computer device first determines a to-be-masked sub-action that has a dependency restriction relationship with the determined target sub-action in a to-be-decided action type based on the determined target sub-action. The following three cases may be specifically included.

1. There is one determined target sub-action that has a dependency restriction relationship with a to-be-masked sub-action in a to-be-decided action type.

In one embodiment, in response to that a j^{th} target sub-action is determined and the dependency restriction situation indicates the dependency restriction relationship between the j^{th} target sub-action and at least one first sub-action in the i^{th} action type, the computer device performs action masking on the first sub-action in the i^{th} action type, where j is less than i (to be specific, a j^{th} action head is serially connected ahead of an i^{th} action head).

For example, if a sprinting action is determined and the dependency restriction situation indicates that there is a dependency restriction relationship between the sprinting action and a squatting action, in response to that the action type, namely, the posture of the first virtual character, is determined, the computer device may perform action masking on the squatting action in the posture action type.

In some embodiments, the computer device may perform one-hot processing on the target sub-action determined by the previous action output head, and then perform matrix multiplication according to a one-hot matrix corresponding to a previous target sub-action and a restriction matrix for representing the dependency restriction relationship between each sub-action in a subsequent action type and a sub-action in a previous action type, to obtain an action masking matrix corresponding to the subsequent action type.

A specific manner is as follows. The computer device transmits the actions determined by the previous action output head to a subsequent action output head based on the action masking matrix.

By way of example, an action type a1 is initiating an attack (including attack and not attack), an action type a2 is a virtual character posture (including squat, jump, creep, and stand), and an action type a7 is a moving state of a virtual character (including crouch, jog, sprint, and idle). The action type a1 corresponds to an action output head H1, the action type a2 corresponds to an action output head H2, and the action type a7 corresponds to an action output head H7. There is a dependency restriction relationship between attack and sprinting, and there is also a dependency restriction relationship between squatting and sprinting. Additionally, because a value of a sub-action is transmitted in a form of a tensor in a neural network, a target sub-action cannot be directly sampled to avoid gradient detachment.

In some embodiments, the action masking matrix corresponding to each action output head may be determined in a training process of the action decision-making model. Using action output heads H1, H2, and H7 as an example, in response to that there are three output sample target actions, the computer device first constructs a one-hot (one-hot) matrix τ_{n×m} based on the three sample target actions, where n=3, indicating that there are three sample target actions, and m=2, indicating an action dimension of a1 (i.e., a quantity of sub-actions included).

In some embodiments, in response to that output sample target sub-actions of the obtained three sample target actions on the action output head H1 are {attack, not attack, attack}, the corresponding one-hot matrix τ_{n×m} of n×m may be expressed as:

$${τ}_{n \times m} = {[ \begin{matrix}01 \\ 10 \\ 01\end{matrix} ]}_{3 \times 2}$$

τ_{n×m} is a one-hot matrix outputted by the action output head H1 in the sampled target actions, a row number is a number n of the sampled target actions, and a column number represents a quantity m of sub-actions included in the action type a2.

Subsequently, the computer device constructs an auxiliary mapping matrix M, namely constructs a mapping matrix that can represent a dependency restriction relationship between a sub-action of the action type a1 and a sub-action of the action type a7. Because a mapping relationship between a target sub-action sample outputted by a single action output head H1 and the action type a7 is constructed, a one-hot matrix formed by combining all different actions in the action output head H1 may be determined as an identity matrix of m×m, a first row maps that the target sub-action is attack, and a second row maps that the target sub-action is not attack.

$$E = {[ \begin{matrix}1 & 0 \\ 0 & 1\end{matrix} ]}_{2 \times 2}$$

Because the action output head H7 corresponds to a dimension P=4, to reflect that sprinting is not performed at the same time when attacking, an auxiliary mapping matrix M_{m×p} may be obtained:

$$M = E \times = {[ \begin{matrix}1111 \\ 1101\end{matrix} ]}_{2 \times }$$

The essence of the matrix M_{m×p} is mapping of H1 to H7, a row number represents a dimension m of a previous action head H1, a column number represents a dimension P of a subsequent affected action head H7, and each row is correspondingly associated with each row in the identity matrix E_{m×m}. A specific value of each row refers to impact of each sub-action in the previous action output head H1 on the subsequent output action head H7.

Finally, the computer device maps impact of not sprinting while attacking in τ_{n×m} to the action output head H7 by matrix multiplication, and obtains an action masking matrix X₇ corresponding to the action output head H7:

$${X}_{7} = {[ \begin{matrix}0 & 1 \\ 1 & 0 \\ 0 & 1\end{matrix} ]}_{3 \times 2} \times {[ \begin{matrix}1 & 1 & 1 & 1 \\ 1 & 1 & 0 & 1\end{matrix} ]}_{2 \times 4} = {[ \begin{matrix}1 & 1 & 0 & 1 \\ 1 & 1 & 1 & 1 \\ 1 & 1 & 0 & 1\end{matrix} ]}_{3 \times 4}$$

The action masking matrix X₇ represents the impact of the sample target sub-actions outputted by the previous action output head H1 on a sub-action in an action type corresponding to the subsequent action output head H7 in all the sample target actions. The size of X₇ is only related to the number of samples and a dimension of the action output head H7. A row number represents that three samples are sampled, and a column number represents different sub-actions in the action type a7. In the foregoing process, a sprinting sub-action corresponding to a target sub-action (attack) determined in all sample target actions has been masked. Then probability distribution conversion is performed on a probability distribution of the sub-action in the action type a7 determined in the action output head H7, to ensure that no sprinting is performed in the action output head H7.

Similarly, the computer device obtains an action masking matrix Y₇ of the target sub-action in the action type a2 on the action type a7 by using the foregoing processing manner. Because both the action type a1 and the action type a2 independently affect the action type a7, the action output head H7 performs superposition processing on the impact of the target sub-action outputted by a previous action on a sub-action in the action type a7, to obtain an action masking matrix L₇ corresponding to the action output head H7:

$${L}_{7} = {X}_{7} ∘ {Y}_{7}$$

The matrix L₇ is a Hadamard product of X₇ and Y₇, and sub-actions in the action type a7 mapped by all elements having a value of 0 in L₇ are masked.

Based on the foregoing manner, the impact of the target sub-action determined previously on the sub-action in the action type corresponding to the subsequent action output head is mapped to the action masking matrix. Thus, the impact is sequentially transmitted backward among the n action output heads, thereby effectively resolving, in a training process of the action decision-making model, a problem that the decision-making model performs massive ineffective exploration in a high-dimensional action space.

2. After at least two determined target sub-actions are combined, there is a dependency restriction relationship with a to-be-masked sub-action in a to-be-decided action type.

In another embodiment, there may be determined target sub-actions, and the two target sub-actions do not independently affect a sub-action in a subsequent action type. After at least two determined target sub-actions are combined, there is a dependency restriction relationship with a sub-action in a to-be-decided action type.

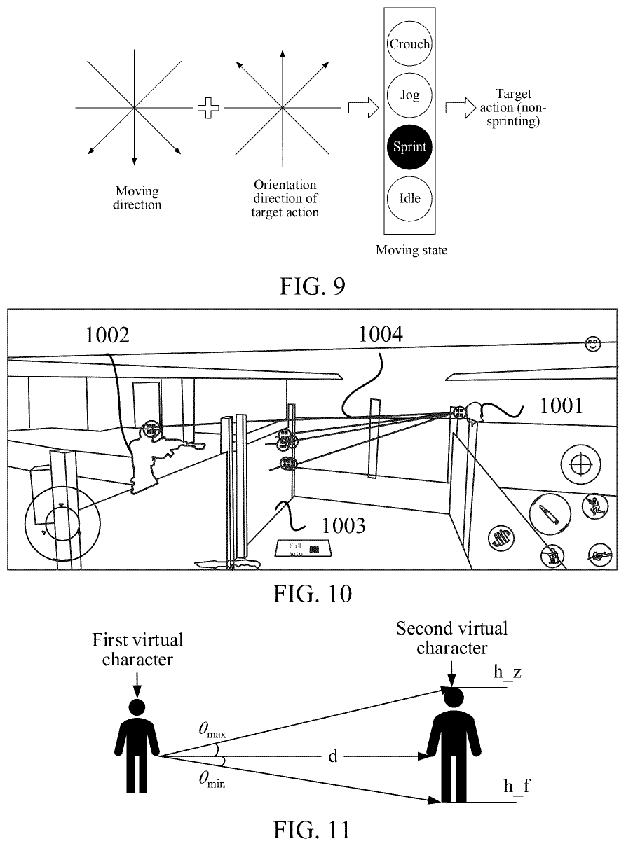

By way of example, refer to FIG. 9, which shows a schematic diagram of impact on a moving state caused by superimposition of a moving direction and an orientation direction according to an exemplary embodiment of the present disclosure. There are two action types: a moving direction and a horizontal turning angle. Neither of sub-actions in the two action types independently affects a sprinting action in a to-be-determined action type. However, in response to that a difference between the horizontal turning angle and the moving direction of the determined target sub-action is relatively large (being 180° in an extreme case), as shown in the figure, a difference between a gazing direction of a first virtual character and the moving direction is 180°. Because the first virtual character is not supported to perform backward sprinting in conventional settings, the first virtual character is not supported to simultaneously perform the sprinting action in this case.

In this case, the computer device may combine target sub-actions outputted by at least two action output heads, thereby determining impact of sub-actions in a to-be-decided action type after the at least two target sub-actions are combined, and mapping the impact to an action masking matrix corresponding to the to-be-decided action type.

Specifically, the computer device may first code respective one-hot matrices of the target sub-actions outputted by the at least two action output heads, concatenate the at least two one-hot matrices to form a combined one-hot matrix, and then perform logical conversion on the combined one-hot matrix, so as to map to an identity matrix. Subsequently, an auxiliary mapping matrix is determined based on the manner shown in the foregoing manner 1, and an impact of a combination of at least two target sub-actions on a to-be-decided action type is determined based on the auxiliary mapping matrix, so as to implement action masking for a sub-action in the to-be-decided action type.

By way of example, an action type a3 is a moving direction (including eight moving directions uniformly distributed within) 360°, an action type a4 is a horizontal orientation (including eight orientation angles uniformly distributed within) 360°, and an action type a7 is a moving state of a virtual character (including crouch, jog, sprint, and idle). The action type a3 corresponds to an action output head H3, the action type a4 corresponds to an action output head H4, and the action type a7 corresponds to an action output head H7.

An action dimension corresponding to the action type a3 is s, and an action dimension corresponding to the action type a4 is h. A one-hot matrix combined by all different sampling sub-actions in the action output header H3 is an identity matrix E_{s×s} of s×s. A one-hot matrix combined by all different sampling sub-actions in the action output header H4 is an identity matrix E_{h×h} of h×h. The computer device performs feature concatenation on the identity matrix E_{s×s} and the identity matrix E_{h×h}, to obtain a combined one-hot matrix T_{(s×h)×(s+h)} which is not a square matrix. A row number s×h represents a combined situation of all actions, and a column number s+h represents a combined dimension, namely, a sum of quantities of sub-actions of the action type a3 and the action type a4. Subsequently, T_{(s×h)×(s+h)} is converted into an identity matrix E_{(s×h)×(s×h)} in which a dimension is s×h. Therefore, each row of the identity matrix represents a case of action combination. Subsequently, a mapping auxiliary matrix M may be determined according to the dependency restriction relationship.

In some embodiments, it is assumed that a combined one-hot matrix corresponding to a sample target sub-action outputted by the action output head H3 and the action output head H4 in all sample target actions is τ_{n×(s+h)}. An action masking matrix corresponding to the action output head H7 may be determined through the following calculation:

First, mapping that transforms each action combination in the sample target action into an approximately one-hot matrix is calculated as:

$${U}_{n \times ( s \times h )} = {τ}_{n \times ( s + h )} \times {X}_{( s + h ) \times ( s \times h )}$$

where X_{(s+h)×(s×h)} is a generalized inverse matrix of T_{(s×h)×(s+h)}, and U_{n×(s×h)} is the mapping that transforms each action combination in the sample target action into an approximately one-hot matrix. Because X_{(s+h)×(s×h)} is an accurate inverse matrix of T_{(s×h)×(s+h)}, U_{n×(s×h)} needs to be converted into an accurate one-hot matrix.

$${Z}_{n \times ( s \times h )} = one - hot ( argmax ( {U}_{n \times ( s \times h )} ) )$$

Each row of Z_{n×(s×h)} represents an action combination of a sample. Each row has s×h matrix values, only one element value is 1, and remaining element values are all 0. The element value of 1 represents that the action combination is associatively mapped with a corresponding row of the mapping auxiliary matrix M, thereby affecting a matrix value of a corresponding row of the action masking matrix corresponding to the action output head H7. F_{n×p} is the action masking matrix in the action output head H7, and each row represents impact of the action type a3 and the action type a4 on a sub-action in the action type a7.

By means of the foregoing calculation, action masking can be implemented in response to that an action combination between different sub-actions has a dependency restriction relationship on a sub-action of a to-be-decided action type, thereby resolving a problem of low exploration efficiency of an action decision-making layer in a complex action space with strong coupling and a high dimension.

3. The character state information and the environment sensing information indicate a situation of a current virtual environment, and have a dependency restriction relationship with the to-be-masked sub-action in the to-be-decided action type. To be specific, it is not suitable to perform a to-be-masked sub-action in the current virtual environment.

In one embodiment, the first virtual character may have a task target such as attacking the second virtual character or evading the second virtual character. Therefore, during action decision-making, the computer device may perform action masking on a sub-action in the to-be-decided action type based on a vision situation of the first virtual character for the second virtual character.

Specifically, the computer device transmits an environment sensing ray to each part of the second virtual character in an orientation direction of the first virtual character by using an eye position of the first virtual character as a start point. A vision situation of each part of the second virtual character in the virtual environment is determined according to a reflection situation of the environment sensing ray. The vision situation may be configured for representing whether each part of the second virtual character is obscured by a cover. In response to that the environment sensing ray is obscured by an obstacle, the part of the second virtual character is invisible. In response to that the environment sensing ray is not obscured by the obstacle and collides with the second virtual character, the part of the second virtual character is visible.

Refer to FIG. 10, which shows a schematic diagram of visual situation sensing according to an exemplary embodiment of the present disclosure. The computer device transmits an environment sensing ray from an eye of a first virtual character 1001 as a start point to each part of a second virtual character 1002. If some sensing rays are obscured by an obstacle 1003, a body part of the second virtual character 1002 corresponding to the rays is invisible. If a sensing ray 1004 is not obscured by an obstacle and collides with a head of the second virtual character 1002, the head of the second virtual character 1002 is visible.

After determining a vision situation of each part of the second virtual character, the computer device performs action masking on a sub-action in a target action type based on the vision situation of each part of the second virtual character.

The target sub-action and the vision situation of each part of the second virtual character have a dependency restriction relationship. For example, in response to that the target action type is a shooting action, if the vision situation of each part of the second virtual character indicates that the second virtual character is invisible, action masking is performed on a “shooting” sub-action in a target action, to avoid frequent shooting when the first virtual character does not aim at an enemy.

After the sub-actions in the target action type are masked, the computer device determines a sub-action from unmasked sub-actions in the target action type by using a target action output head.

In another embodiment, in response to that the first virtual character has a requirement for aiming at the second virtual character, the computer device may first determine a turning angle range at which the second virtual character can be aimed, and then perform action masking on a turning angle, in a turning action type, at which the first virtual character cannot aim at the second virtual character.

Refer to FIG. 11, which shows a schematic diagram of determining an effective aiming range in a vertical direction according to an exemplary embodiment of the present disclosure. First, a distance d between a first virtual character and a second virtual character is determined according to coordinates of a position of the second virtual character and coordinates of a position of the first virtual character, and a height h of the second virtual character is obtained, where h=h_z−h f. Therefore, the second virtual character may be aimed at in response to that a sight of a virtual item held by the first virtual character falls within a height range of the first virtual character in a vertical direction, and according to a trigonometric function, it may be obtained that:

$${θ}_{max} = ac tan [ ( h\_z - h\_f ) / d ]$$

$${θ}_{min} = ac tan [ ( h\_f - h\_z ) / d ]$$

$${τ}_{pitch} = {θ}_{max} - {θ}_{min}$$

where a horizontal direction is a current orientation direction, namely 0°, θₘₐₓ is an effective aiming range of upward rotation, θₘᵢₙ is an effective aiming range of downward rotation, and a difference τ_{pitch} between the effective aiming ranges is an effective aiming range of a value turning action.

For a horizontal turning angle, the computer device may determine an effective aiming range according to the distance d between the first virtual character and the second virtual character and widths of the virtual characters, to mask sub-actions in a horizontal turning action type, so that the first virtual character can aim at the second virtual character after executing a target sub-action in unmasked sub-actions.

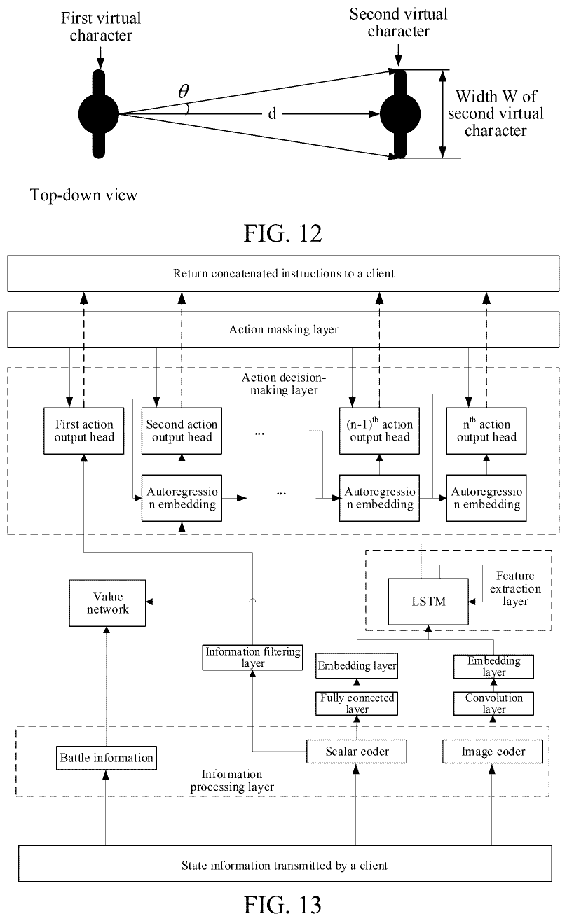

By way of example, refer to FIG. 12, which shows a schematic diagram of an effective aiming range in a horizontal direction according to an exemplary embodiment of the present disclosure. A current orientation of a first virtual character is 0°, a distance between the first virtual character and a second virtual character is d, and a width of the second virtual character is W. Therefore, an effective aiming range is determined as:

$$θ = ac tan [ ( W / 2 ) / d ]$$

$${τ}_{pitch} = 2 θ$$

where θ is an effective rotation range of clockwise and anticlockwise rotation angles of the first virtual character, and an effective clockwise rotation range is combined with an effective anticlockwise rotation range, to obtain an effective aiming range τ_{pitch}.

Subsequently, the computer device determines an effective horizontal turning angle based on the effective aiming range, and the determined effective horizontal turning angle is that the orientation of the first virtual character after executing a turning action according to a fine turning angle at the current orientation is within the effective aiming range.

Further, the computer device performs action masking on a turning angle not belonging to the effective horizontal turning angle in a horizontal turning action, and determines a target horizontal turning angle from unmasked effective horizontal turning angles in the horizontal turning action by using a horizontal turning action output head. Finally, the first virtual character executes a target horizontal turning action, so as to aim at the second virtual character.

In one embodiment, to prevent the target action from frequently making an action, which does not satisfy human behavior logic, the computer device may set a cooling time for some sub-actions, and in response to that cooling of the sub-action is not completed, the sub-action is subjected to action masking. In this way, it is avoided that the first virtual character repeatedly executes a same action to cause a twitch phenomenon.

In this embodiment of the present disclosure, a sub-action in a to-be-decided action type is subjected to action masking based on three different dependency restriction situations and a determined target sub-action, thereby improving action decision-making efficiency in a complex action space of a high dimension and saving computing resources to some extent.

Refer to FIG. 13, which shows a schematic diagram of an action decision-making model according to an exemplary embodiment of the present disclosure. An action masking layer, an information processing layer, a feature extraction layer, and an action decision-making layer are included. The computer device codes, by using a scalar coder and an image coder, obtained state information (character state information and environment sensing information) of a game battle where the first virtual character is involved, and then performs feature concatenation by using a fully connected layer and an embedding layer to obtain an input feature extraction layer (LSTM network). Feature extraction is performed on a concatenated state feature by using the LSTM network, to obtain a fusion feature. Additionally, after the fusion feature is inputted to the action decision-making layer, a target action is determined by using the action decision-making layer. The target action includes a plurality of target sub-actions, where n target sub-actions are respectively serially outputted by using n action output heads. In a process of determining the target sub-actions, action masking is performed on a sub-action having a dependency restriction relationship by using the action masking layer.

In addition, in a model training process, the action decision-making model further includes a value network. Value evaluation is performed for the determined target sub-action by using the value network, and the action decision-making model is adjusted according to a value obtained through evaluation. In addition, some battle information may further be inputted to the value network, so that the value network can determine a value of a sample target sub-action according to a current battle situation.

Before the action decision-making model is applied, the action decision-making model is to be trained in a training game battle. A training process of the action decision-making model is described below by using an exemplary embodiment.

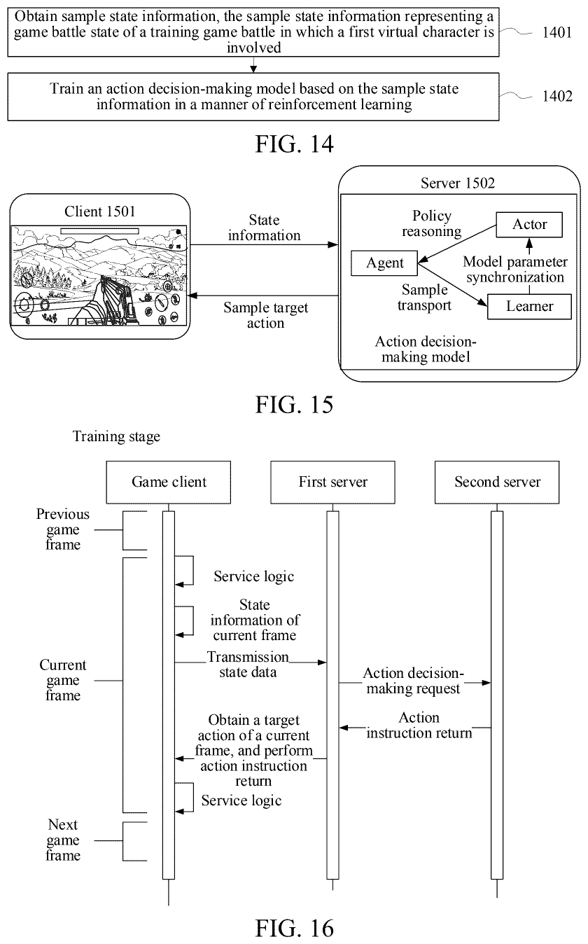

Refer to FIG. 14, which shows a flowchart of a training process of an action decision-making model according to an exemplary embodiment of the present disclosure. The process includes the following operations.

Operation 1401: Obtain sample state information, the sample state information representing a game battle state of a training game battle in which a first virtual character is involved.

For this operation, refer to the process of obtaining state information in operation 201. Details are not described herein again.

Operation 1402: Train an action decision-making model based on the sample state information in a manner of reinforcement learning.

The process of training the action decision-making model based on reinforcement learning includes the following content.

Operation 1402a: Input the sample state information to the action decision-making model, to obtain a sample target action outputted by the action decision-making model, the sample target action including n sample target sub-actions.

Actually, the process of training the action decision-making model is a process of reinforcement training of an action decision-making layer in an action model.

For a specific implementation of this process, refer to the content of determining a target action in the foregoing embodiments. Details are not described again in this embodiment.

Operation 1402b: Control the first virtual character to execute the sample target action, to obtain a sample action execution result of the first virtual character.

The sample action execution result includes a change of state information of a game battle in which the first virtual character executes the sample target action.

Operation 1402c: Determine an action execution reward based on the sample action execution result of the first virtual character.

In a training process, a corresponding action execution task is usually set for the first virtual character. Therefore, to avoid that the first virtual character takes an extreme operation to complete a target task, resulting in a relatively low anthropomorphic degree of the first virtual character. In addition to determining an execution reward of the target action based on a task progress, the computer device may further determine an execution reward of the sample target action based on an anthropomorphic degree of the sample target action.

First, the computer device determines a weight coefficient ratio for executing reward and punishment items. The action execution reward may be classified into a dominant reward (i.e., a reward for the progress of the target task) and an auxiliary anthropomorphic reward. In an early stage of training of the action decision-making model, the computer device increases a weight of the dominant reward and decreases a weight of the auxiliary anthropomorphic reward, so that the action decision-making model preferentially uses task completion as a target to learn action decision-making. After a plurality of rounds of training, strength of the action decision-making model continuously increases, so that the computer device needs to adjust a coefficient ratio of the auxiliary anthropomorphic reward according to performance of the action decision-making model and a change trend of a corresponding anthropomorphic index. The anthropomorphic index is a matching degree between a probability that the first virtual character executes a particular action and a probability that a real player executes a feature action. For example, in response to that the first virtual character cannot properly use a cover to perform a hit-and-run combat in a game battle, it may be considered that the weight of the dominant reward is excessively large. Thus, the computer device needs to reduce the weight of the dominant reward, to ensure that the action decision-making model can determine an anthropomorphic target action based on particular strength.

In some embodiments, the information processing layer further includes a game battle information coder. The sample state information further includes sample battle information. The sample battle information represents a real-time situation of the training game battle in which the first virtual character is involved. In one embodiment, in response to that the sample battle state information is inputted into the action decision-making model, the computer device first codes the sample battle information by using a game battle information coder, to obtain a game battle state code, and then determines an action execution reward based on the game battle state code and a sample action execution result. In this way, the action decision-making model can objectively determine, according to global battle information, a reward brought by the current target action, thereby reducing a variance of value estimation, and improving training efficiency.

In this embodiment of the present disclosure, the action execution reward mainly includes at least one of an attribute reward, a game battle victory reward, a game battle defeat reward, and a task reward.

The attribute reward mainly includes a life value attribute reward of the first virtual character. In response to that an attribute value of the first virtual character decreases, the computer device may determine the attribute reward as the action execution reward. For example, after the first virtual character executes the sample target action, if the life value attribute of the first virtual character decreases, it is determined that the target action obtains a negative attribute reward. Alternatively, in response to that the attribute value of the first virtual character increases, the computer device may determine the attribute reward as the action execution reward. For example, after the first virtual character executes the sample target action, if the life value attribute of the first virtual character increases, it is determined that the target action obtains a positive attribute reward.

The game battle defeat reward refers to that an extremely large negative reward (i.e., punishment) is obtained in response to that the first virtual character is defeated in the game battle. In response to that the first virtual character is defeated in the game battle, the computer device may determine the game battle defeat reward as the action execution reward.

The game battle victory reward is contrary to the game battle defeat reward. In response to that the first virtual character achieves a game battle victory, an extremely positive reward is obtained. In response to that the attribute value of the first virtual character decreases, the computer device may determine the attribute reward as the action execution reward.

In some embodiments, the first virtual character has a target task in a game battle, for example, guarding a treasure chest, evading pursuit, or reaching a designated location. Therefore, in response to that the first virtual character achieves a task victory in a training game battle, the computer device may determine the task reward as the action execution reward.

In addition, to enable the action decision-making model to make an anthropomorphic action decision, the action execution reward further includes an anthropomorphic reward.

In some embodiments, the computer device determines anthropomorphic attribute values of at least two sample target actions based on sample action execution results obtained after the first virtual character executes the at least two sample target actions in the training game battle. The anthropomorphic attribute value may be a quantity of particular actions, walking positions of at least two sample target actions determined consecutively, and the like. The computer device may determine the anthropomorphic reward as the action execution reward in response to that the anthropomorphic attribute values are less than an anthropomorphic attribute threshold.

By way of example, refer to Table 3, which shows an action execution reward provided by an exemplary embodiment of the present disclosure.

TABLE 3

| Category | Subcategory | Reward/punishment setting |
|---|---|---|
| Dominant reward | Task target reward | Attribute change |
| | | Battle victory/defeat |
| | | Task success/failure |
| Auxiliary | Posture | Proper leaning |
| anthropomorphic | anthropomorphic | Proper squatting |
| reward | reward | Proper crouching |
| | | Excessive turning |
| | | punishment |
| | | Moving dispersion |
| | Combat | Attack ratio after three |
| | anthropomorphic | seconds of evasion |
| | reward | Attack ratio after |
| | | 2.5 s of evasion |
| | | Cover utilization |
| | | Staying in dangerous areas |
| | | Shooting then retreating |
| | | Ambushing from shadows |
| | | Long-range attacks |
| | | Attacking when opponents |
| | | approach |
| | | Peeking in critical moments |
| | | Attack ratio |

In the foregoing table, some action rewards need to be determined according to a plurality of successive sample target actions. For example, proper leaning is an anthropomorphic reward, and a virtual character controlled by a real player usually does not lean repeatedly within a short time, or does not lean when there is no cover around. Therefore, in the determined plurality of sample target actions, when an anthropomorphic attribute value of a leaning action (i.e., the number of leaning actions) exceeds an anthropomorphic attribute threshold, the computer device determines that the leaning action is an improper leaning action, and gives a negative reward based on the action decision-making model.

Table 3 includes a moving dispersion reward, a cover utilization reward, an ambushing from shadows reward, and a proper action reward (proper leaning, proper squatting, proper crouching, and the like).

1. The moving dispersion reward is a reward that closeness of continuous repeated moving is reduced in response to that the first virtual character executes a sample target action. To be specific, the first virtual character does not wander in situ continuously for many times, and can move more dispersedly on a large-scale map, to explore different positions of the map.

In some embodiments, the sample action execution result includes a position point of the first virtual character after first n+1 actions are executed. The computer device determines, based on a position point of the first virtual character after an (n+1)^{th} action is executed, first closeness between the position point after the (n+1)^{th} action is executed and a position point after first n actions are executed, and determines second closeness between a position point after an nth action is executed and a position point after first n−1 actions are executed. In response to that the first closeness is less than the second closeness, the computer device determines the moving dispersion reward as an action execution reward.

When the action decision-making model is trained, a phenomenon that the first virtual character traps around in a local region may be caused. Therefore, to avoid the phenomenon, after the computer device guides, based on a close centrality algorithm, the first virtual character to execute the sample target action decided by the action decision-making model, moving is sufficiently dispersed, with moving paths covering the global map as much as possible, so as to train a moving capability of the first virtual character.

Specifically, in response to that the closeness between the position point after the (n+1)^{th} action is executed and the position point after the first n actions are executed is less than the closeness between the position point after the nth action is executed and the position point after the first n−1 actions are executed, the computer device determines that a positive moving dispersion reward is obtained. Alternatively, in response to that the closeness between the position point after the (n+1)^{th} action is executed and the position point after the first n actions are executed is greater than the closeness between the position point after the nth action is executed and the position point after the first n−1 actions are executed, the computer device determines that a negative moving dispersion reward is obtained. Thus, the first virtual character is guided to get away from a historical position that has been recently visited as far as possible, to avoid a case that the virtual character wanders in situ.

2. The cover utilization reward refers to a reward at a position adjacent to a cover in response to that the first virtual character executes the sample target action. In response to that there is a second virtual character, it is expected that the first virtual character can be located beside the cover to the greatest extent, to prevent from being attacked by the second virtual character.

In some embodiments, the sample action execution result includes sample state information of the first virtual character after executing the sample target action, including sample character state information and sample environment sensing information. The sample environment sensing information includes a two-dimensional depth map. The two-dimensional depth map represents a masking situation of the first virtual character by an obstacle in the orientation direction of the first virtual character.

The computer device divides a two-dimensional depth map region to obtain at least two depth regions, and determines a first masking rate of a first depth region and second masking rates of at least two second depth regions adjacent to the first depth region. The first depth region is located at a center of view of the first virtual character. Further, the computer device determines a cover utilization reward based on a minimum difference between the first masking rate and the second masking rate, and determines the cover utilization reward as the action execution reward. A reward degree of the cover utilization reward is in a positive correlation with the minimum difference.

In this embodiment of the present disclosure, the cover utilization reward is determined by remolding a depth map matrix. In a game scene, the cover is a region providing masking for the first virtual character in a combat process of the first virtual character. There are a plurality of covers in a virtual environment, and at least one of positions, orientations, and shapes of different covers is different. However, in the two-dimensional depth map, an obstacle depth situation in the orientation direction of the first virtual character can be represented. Therefore, the computer device may determine a pixel distribution region of the cover according to a pixel value distribution situation of the two-dimensional depth map.

In some embodiments, the computer device performs division according to a depth map value direction, to obtain a total of 19 regions, 1 to 19, divides the depth map vertically into several columns, and calculates brightness of each column. A higher brightness indicates a brighter front, a lower possibility of obscuring by an obstacle, and a lower masking rate. In an application, it is usually expected that the first virtual character can select a region in which a cover exists and the second virtual character can be attacked. Therefore, a middle column of the depth map needs to have a minimum brightness, and the middle column reflects view information right in front of the first virtual character. A smaller brightness indicates a larger masking rate, and a higher possibility that the cover region is right in front. In addition, it is expected that the first virtual character can be located at the edge of the cover. To be specific, an attack can be initiated on the second virtual character by means of an action such as leaning. Therefore, an absolute value of a difference between a brightness rate in the middle column and a relatively large brightness rate in the left and right columns of the first virtual character is as large as possible. To be specific, a minimum value of a difference between the brightness rate in the middle column and the brightness rates (masking rates) in the left and right columns is as large as possible. For example, it is expected that a masking rate in a 10^{th} column is as large as possible, and a masking rate of a region in a 9^{th} column and an 11^{th} column is as small as possible.

In some embodiments, brightness vⱼ corresponding to a depth region may be calculated by using the following formula:

$${v}_{j} = \frac{{\sum }_{i = 1}^{i = n} {x}_{i , j}}{{\sum }_{i = 1}^{i = n} 1}$$

where vⱼ is a ratio of actual pixels in each depth region to a sum of theoretical maximum pixels in each column, and a masking rate of the depth region is 1-vⱼ. The cover utilization reward may be calculated by using the following formula:

$$r = α \cdot ( 1 - {v}_{10} ) + β \cdot \vert 1 - {v}_{10} - min ( 1 - {v}_{9} , 1 - {v}_{11} ) \vert$$

where r is the cover utilization reward, and α and β are reward hyper-parameters.

The manner of dividing the two-dimensional depth map region may alternatively be performing division based on a horizontal direction, or the quantity of divided regions may be adjusted based on a specific virtual environment. In response to that the virtual environment is relatively complex, more depth regions may be used for performing more refined division on the two-dimensional depth map, thereby obtaining a finer cover effect. In response to that a map scene is relatively large, a control structure is relatively simple, and then the depth region may be divided in a coarse granularity. This is not limited in this embodiment.

3. The ambushing from shadows reward is a visible reward. The visible reward is a reward at a position which is an effective attack position for a second virtual character in response to that the first virtual character executes the sample target action. In response to that there is a second virtual character, it is expected that the second virtual character can be located at a visible position of the first virtual character, but the first virtual character is not located at a visible position of the second virtual character, which is beneficial to initiating an attack.

In some embodiments, the sample action execution result includes a mutual vision relationship between the first virtual character and the second virtual character. The mutual vision relationship represents a vision situation of the first virtual character and the second virtual character relative to each other.

In some embodiments, the computer device determines that the action execution reward is a positive visible reward in response to that the mutual vision relationship indicates that the first virtual character is not within the vision range of the second virtual character and the second virtual character is within the vision range of the first virtual character.

The computer device determines that the action execution reward is a negative visible reward in response to that the mutual vision relationship indicates that the first virtual character is within the vision range of the second virtual character and the second virtual character is not within the vision range of the first virtual character.

To be specific, in response to that the first virtual character is at a favorable attack position relative to the second virtual character, it is determined that a positive visible reward is obtained. Otherwise, in response to that the first virtual character is at a disadvantageous attack position relative to the second virtual character, it is determined that a negative visible reward is obtained.

In some embodiments, the mutual vision relationship may be obtained in a ray detection manner. The computer device transmits an environment sensing ray to each part of the second virtual character in an orientation direction of the first virtual character by using an eye position of the first virtual character as a start point, and determines a vision situation of each part of the second virtual character in the virtual environment according to a reflection situation of the environment sensing ray. The vision situation may be configured for representing whether each part of the second virtual character is obscured by a cover. When the vision situation indicates that each part of the second virtual character is obscured by an obstacle, it is determined that the second virtual character is not within the vision range of the first virtual character. Similarly, the computer device transmits an environment sensing ray to each part of the first virtual character in an orientation direction of the second virtual character by using an eye position of the second virtual character as a start point, and determines a vision situation of each part of the first virtual character according to a reflection situation of the environment sensing ray. When the vision situation indicates that each part of the first virtual character is obscured by an obstacle, it is determined that the first virtual character is not within the vision range of the second virtual character.

4. The proper action reward is a reward that conforms to operation logic of a real player in response to that the first virtual character executes the sample target action. In a model training process, it is expected that a behavior of the first virtual character can be anthropomorphic as much as possible, and a behavior more conforming to human logic can be executed.

Before determining the sample target action, the computer device determines an ideal action of the first virtual character based on battle information (including sample character state information and sample environment sensing information) of a training game battle. For example, if the environment sensing information represents that there is a relatively low cover in front of the first virtual character, it may be that the ideal action of the first virtual character may be a squatting action. For another example, if the environment sensing information represents that there is a second virtual character on the right hand side of the first virtual character, it may be determined that the ideal action is turning to the right.

Subsequently, in response to that the sample target action corresponding to the action decision-making model is consistent with the ideal action, the computer device determines the proper action reward as the action execution reward.

In some embodiments, the computer device transmits an environment sensing ray to the surroundings by using the first virtual character as a start point. Different environment sensing rays are located at a same horizontal height, and surrounding obstacle distribution is determined according to a reflection situation of the environment sensing ray. In response to that a length of a shortest environment sensing ray is less than a distance threshold, the first virtual character is close to an obstacle, and it may be determined that turning is required in this case. The environment sensing ray diffuses to two sides by using the shortest ray as a reference, and the computer device determines that a ray direction of the environment sensing ray having a ray length exceeding the distance threshold earlier is an ideal turning direction of the first virtual character.

In response to that a turning direction determined by the action decision-making model is consistent with the ideal turning direction, the computer device determines the proper action reward as the action execution reward. When the turning direction determined by the action decision-making model is inconsistent with the ideal turning direction, the first virtual character may exhibit a wall-stuck behavior, and the computer device gives a negative reward.

Operation 1402d: Update a model parameter of the action decision-making model based on the action execution reward.

The process of updating the action decision-making model based on the action execution reward is a process of updating a model parameter of the action decision-making model to obtain a larger action execution reward, so that the action decision-making model can implement an anthropomorphic action as much as possible while executing a target task.

In this embodiment of the present disclosure, in a process of training an action decision-making model, an auxiliary anthropomorphic action reward is added, so that dual requirements on model strength and anthropomorphization can be satisfied. In addition, with reference to action mask logic, the anthropomorphization of a virtual character is greatly improved, and behavior logic of a real player is more satisfied.

In this embodiment of the present disclosure, at least one second virtual character exists in the training game battle in which the first virtual character is involved, and the second virtual character executes an action outputted by a second action decision-making model. In some scenes, a target task of the second virtual character corresponds to a target task of the first virtual character. For example, the target task of the first virtual character is guarding a treasure chest, and the target task of the second virtual character may be grabbing a treasure chest.

The second virtual character is used as an opponent virtual character. After a first action decision-making model corresponding to the first virtual character is trained, iterative training also needs to be performed on a second action decision-making model, to obtain second action decision-making models of different strengths.

Specifically, in response to that the first action decision-making model corresponding to the first virtual character completes an i^{th} round of training, the i^{th} round of training is performed on the second action decision-making model based on the trained first action decision-making model, and the second action decision-making model completing the i^{th} round of training is stored into an evaluation model pool.

For the first action decision-making model corresponding to the first virtual character, in response to that a training game battle ends, the computer device determines that the action decision-making model completes the i^{th} round of training. Subsequently, the action decision-making model completing the i^{th} round of training is evaluated, to obtain a corresponding performance evaluation result.

In some embodiments, the computer device selects at least two trained control models from the evaluation model pool, and then creates at least two evaluation game battles. The evaluation game battles include a first virtual character executing an output action of the action decision-making model and a second virtual character executing an output action of the control model. Then, a performance evaluation result is determined according to battle data of the at least two evaluation game battles.

An index of the performance evaluation may be a success rate of a game battle, a proportion of particular behaviors in the game battle, or the like. This is not limited in this embodiment.

When the performance evaluation result indicates that the action decision-making model does not reach a training completion criterion, the computer device needs to control the action decision-making model to enter an (i+1)^{th} round of training. To be specific, when the performance evaluation result indicates that the action decision-making model does not reach the training completion criterion, the computer device needs to control the action decision-making model to enter a next round of training.

It is determined that the action decision-making model completes training when the performance evaluation result indicates that the action decision-making model reaches the training completion criterion.

By way of example, specific processes are as follows.

(1) An opponent virtual character is controlled based on a built-in behavior tree of a client, to perform a oth round of training on a first action decision-making model. (2) The model completing the 0^{th} round of training is stored into an evaluation model pool and is evaluated. (3) A 0^{th} round of training is performed on a second action decision-making model according to the first action decision-making model completing the 0^{th} round of training, and the second action decision-making model is added to an opponent model pool. (4) A previously trained second decision-making model is selected from the opponent model pool as an opponent, and a K^{th} round of training is performed on the first action decision-making model. (5) The first action decision-making model completing the K^{th} round of training is stored into an evaluation model pool and is evaluated. (6) A K^{th} round of training is performed on the second action decision-making model according to the first action decision-making model completing the K^{th} round of training, and the second action decision-making model is added to the opponent model pool. (7) Operations in (4) to (6) are repeated, until the first action decision-making model completes training in response to that an evaluation result of the first action decision-making model satisfies a performance evaluation result.

In this embodiment of the present disclosure, the second action decision-making model corresponding to the accompanying opponent virtual character and the first decision-making model corresponding to the first virtual character are trained, thereby improving strength of the first decision-making model, and enabling the first decision-making model to have a stable action decision-making capability.

In this embodiment of the present disclosure, whether the action decision-making model has been trained needs to be determined with reference to a game battle index and an anthropomorphic index. The game battle index is configured for judging strength of the action decision-making model, and the anthropomorphic index is configured for judging an anthropomorphic degree of the action decision-making model.

Refer to Table 4, which shows a game battle index and an anthropomorphic index provided by an exemplary embodiment of the present disclosure.

TABLE 4

| | | Anthropomorphic index (statistics are collected | |
|---|---|---|---|
| | | over 500 battles and an anthropomorphic index is | |
| Battle index | | averaged per battle) | |
| Draw rate | Battle ending in a draw | Leaning rate | Attack on a second virtual |
| | | | character with proper leaning |
| Win rate | A first virtual character | Squatting rate | Probability of hiding from being |
| | defeats a second virtual | | detected by an opponent by |
| | character | | properly using a squatting action |
| Loss rate | A first virtual character | Evasion rate | Average proportion of remaining |
| | is defeated by a second | | undetected per battle |
| | virtual character | | |
| Engagement | Frames attacking with an | Crouch rate | Proportion of a first virtual |
| attack rate | enemy present/total | | character hiding sound to avoid |
| | frames with an enemy | | being detected by crouching |
| | present | | |
| Accuracy | Frames hitting on an | Cover | Proportion of a first virtual |
| fire rate | enemy with the enemy | utilization | character being hidden by using a |
| | present/total frames | rate | cover |
| | attacking with an enemy | | |
| | present | | |
| Survival | Duration of survival of a | Moving | A first virtual character moves |
| time | first virtual character in a | dispersion | freely, and does not stay at a same |
| | round of game | rate | position for a long time |
| Wall-stuck | Number of frames where | Dangerous | Frequency that a first virtual |
| count | a character is within 30° | area loitering | character is in a dangerous clear |
| | of an obstacle and less | rate | area without a cover in a particular |
| | than 0.5 m distant from | | combat scene |
| | the obstacle | | |
| | | Excessive | A moving orientation of a first |
| | | turning rate | virtual character is not required to |
| | | | change dramatically |
| | | Hit-and- | A first virtual character can |
| | | retreat rate | actively move away from a second |
| | | | virtual character while shooting at |
| | | | the second virtual character |
| | | Flanking shot | A first virtual character shoots at a |
| | | rate | second virtual character from |
| | | | outside its field of view |
| | | Prolonged | For characterizing an |
| | | combat rate | anthropomorphic behavior for hit- |
| | | | and-run combat using a cover |

When the anthropomorphic index is determined, an average anthropomorphic index is determined according to a large amount of battle data.

In response to that an i^{th} round of training of the action decision-making model is completed, the computer device obtains battle data of an i^{th} round of training game battle. A game battle index and an anthropomorphic index are determined based on the game battle data of at least two rounds of training game battle. The anthropomorphic index is an actual execution proportion of a particular action in the game battle data of at least the training game battle.

In response to that the game battle index reaches a training completion criterion and the anthropomorphic index matches a target execution proportion that a real player executes a particular action in a game battle, it is determined that the action decision-making model completes training.

In this embodiment of the present disclosure, the game battle index and the anthropomorphic index are both used as evaluation criteria of the action decision-making model, so that the trained action decision-making model can take both strength and the anthropomorphic degree of the action model into consideration.

Refer to FIG. 15, which shows a schematic diagram of interaction between a client and a server for training an action decision-making model in a training process according to an exemplary embodiment of the present disclosure. A client 1501 is an application installed in a computer device and configured to provide a virtual environment. A server 1502 is configured to provide an action model training service. In a training process, the client 1501 transmits state information to the server 1502. After receiving the state information, the server 1502 processes and concatenates the state information into an input feature of an action decision-making model by using an Agent component in the action decision-making model, and then requests an Actor component to obtain a sample target action of a current policy. In addition, the sample target action is mapped to generate a response packet to be transmitted to the client 1501. Additionally, reward calculation and sample processing are performed on data generated in this process, to generate training samples, and the training samples are transmitted to a Learner component in batches for policy parameter optimization. The training sample received by the Learner component is stored into a local buffer pool, and each training operation is used from the buffer pool according to a policy. After performing several operations of training, the Learner component synchronizes a parameter in a current training network to a target network in the Actor. In this embodiment of the present disclosure, training may be performed by using a proximal policy optimization (PPO) algorithm.

Refer to FIG. 16, which shows a schematic diagram of a decision-making mode implementing an action decision-making request in a training process according to an exemplary embodiment of the present disclosure.

In a training process, a client uses a synchronous decision-making mode. To be specific, after transmitting state information, the client waits for an action packet returned by a server, and executes a sample target action based on the action packet. When an action decision needs to be made, state information is transmitted to a first server in a game frame, and the first server transmits request data to a second server providing an action decision-making service. After the action decision is made, the second server returns response data to the first server, and waits for a next frame of action decision-making request. The first server obtains a sample target action, and then returns an action instruction to the client to control a target virtual character to execute the sample target action. The synchronous decision-making mode is configured for ensuring a model training effect.

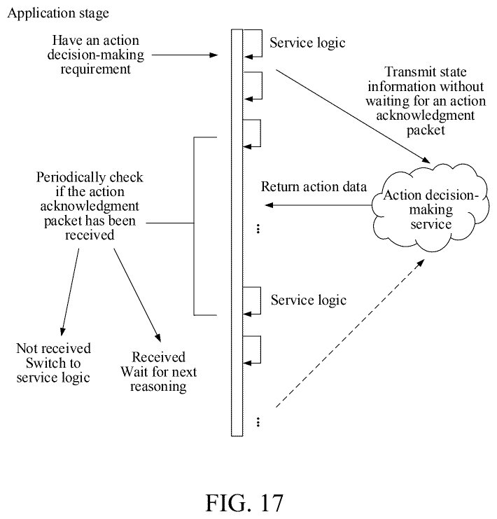

Refer to FIG. 17, which shows a schematic diagram of a decision-making mode implementing an action decision-making request in an application process according to an exemplary embodiment of the present disclosure. In an application stage, an asynchronous decision-making mode is used. After transmitting state information to a first server, a client does not wait for a returned action packet. After the state information is transmitted, other service logics are run while whether a returned action packet is received is periodically checked. In response to that the returned action packet is not received, the service logic is continued. In response to that the returned action packet is received, after a target virtual character is controlled to execute a target action, a next action decision waits for being made. In the application stage, the asynchronous decision-making mode is used, so that data blocking of a main thread can be effectively reduced, to ensure that a time consumption of reasoning by an action decision-making model does not affect other service logics, to reduce occupation of a resource of a server (the first server) on the service side, and ensure security of the action decision-making model.

In one embodiment, the computer device may train the action decision-making model in a manner of combining supervised learning and reinforcement learning. In an early stage of training, the computer device first trains the action decision-making model in the supervised learning manner based on battle data of a real player, thereby effectively avoiding meaningless exploration of the reinforcement learning in the early stage of training the action decision-making model. Then, the reinforcement learning manner is used in subsequent training, thereby effectively improving efficiency of training the action decision-making model.

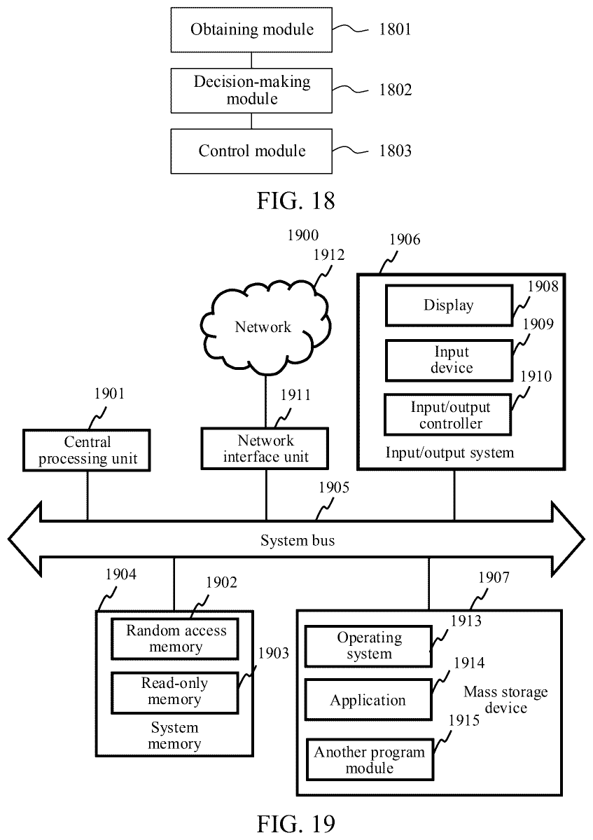

Refer to FIG. 18, which shows a schematic structural diagram of a virtual character action decision-making apparatus according to an exemplary embodiment of the present disclosure. The apparatus includes the following structures.

An obtaining module 1801 is configured to obtain state information, the state information representing a game battle state of a game battle in which a first virtual character is involved.

A decision-making module 1802 is configured to input the state information to an action decision-making model, to obtain n target sub-actions serially outputted by n action output heads in the action decision-making model, different action output heads corresponding to different action types, the n action output heads being serially connected based on a dependency relationship between the action types, the dependency relationship representing a dependency restriction situation between sub-actions under different action types, and n being a positive integer.

The control module 1803 is configured to control the first virtual character to execute a target action formed by the n target sub-actions.

In some embodiments, the action decision-making model includes an information processing layer, a feature extraction layer, and an action decision-making layer, the action decision-making layer including the n action output heads.

The decision-making module 1802 is configured to:
input the state information to the action decision-making model, and code the state information by using the information processing layer, to obtain a state code;
input the state code to the feature extraction layer, and extract a state code feature by using the feature extraction layer, to obtain a fusion feature; and
determine the n target sub-actions by using the n action output heads in the action decision-making layer based on the fusion feature.

In some embodiments, the decision-making module 1802 is configured to:
input the fusion feature to a first action output head in the action decision-making layer, and determine a first target sub-action from a first action type by using the first action output head; and
input embedding coded vectors respectively corresponding to the determined first target sub-action to an (i−1)^{th} target sub-action and the fusion feature to the action decision-making layer, and determine an i^{th} target sub-action from an i^{th} action type by using an i^{th} action output head in the action decision-making layer, the first target sub-action to the (i−1)^{th} target sub-action being respectively determined by using the first action output head to an (i−1)^{th} action output head, i being less than or equal to n, and i being greater than 1.

In some embodiments, the action decision-making model further includes an action masking layer, the action masking layer being connected to the n action output heads in the action decision-making layer, and the action masking layer being configured for masking sub-actions of different action types.

The apparatus further includes:
an action masking module, configured to mask a sub-action in the i^{th} action type based on the determined first target sub-action to the (i−1)^{th} target sub-action and a dependency restriction relationship indicated by the dependency restriction situation between sub-actions under different action types, at least two sub-actions having the dependency restriction relationship being not supported to be executed simultaneously.

The decision-making module 1802 is configured to determine, by using the i^{th} action output head in the action decision-making layer, the i^{th} target sub-action from sub-actions not masked in the i^{th} action type.

In some embodiments, the decision-making module 1802 is configured to:
mask, in response to that a j^{th} target sub-action is determined and the dependency restriction situation indicates the dependency restriction relationship between the j^{th} target sub-action and at least one first sub-action in the i^{th} action type, the first sub-action in the i^{th} action type, j being less than i;
or,
mask, in response to that an xth target sub-action and a yth target sub-action are determined and the dependency restriction situation indicates the dependency restriction relationship between a combination of the xth target sub-action and the yth target sub-action and at least one second sub-action in the i^{th} action type, the second sub-action in the i^{th} action type, x and y being less than i.

In some embodiments, the state information includes character state information of the first virtual character in the game battle and environment sensing information of a virtual environment in which the first virtual character is located, the character state information representing an interaction state between the first virtual character and a second virtual character in the game battle and an interaction state between the first virtual character and the virtual environment in the game battle, the character state information being a one-dimensional vector, the environment sensing information being a two-dimensional image, and the information processing layer including a scalar coder and an image coder.

In some embodiments, the decision-making module 1802 includes:
input the state information to the action decision-making model, and code the character state information by using the scalar coder in the information processing layer, to obtain a state information coding result;
code the environment sensing information by using the image coder in the information processing layer, to obtain an environment information coding result; and
concatenate the state information coding result and the environment information coding result by using the information processing layer, to obtain the state code.

In some embodiments, the action decision-making model further includes an information filtering layer, the information filtering layer being connected to an output end of the scalar coder, and the information filtering layer being connected to an input end of the action decision-making layer.

The apparatus further includes:
a filtering module, configured to: filter the character state information by using the information filtering layer in response to that the character state information is obtained, to obtain filtered character state information, the filtered character state information having a correlation relationship with a first action type corresponding to a first action output head; and input the filtered target character state information to the first action output head.

In some embodiments, the apparatus further includes:
a decomposition module, configured to orthogonally decompose an executable
action of the first virtual character, to obtain the n action types, different action types including at least two executable sub-actions, and sub-actions under different action types being supported to be independently controlled.

In some embodiments, the apparatus further includes:
a training module, configured to obtain sample state information, the sample state information representing a game battle state of a training game battle in which the first virtual character is involved.

The training module is further configured to train the action decision-making model based on the sample state information in a manner of reinforcement learning.

In some embodiments, the training module is configured to:
input the sample state information to the action decision-making model, to obtain a sample target action outputted by the action decision-making model, the sample target action including n sample target sub-actions;
control the first virtual character to execute the sample target action, to obtain a sample action execution result of the first virtual character;
determine an action execution reward based on the sample action execution result of the first virtual character; and
update a model parameter of the action decision-making model based on the action execution reward.

In some embodiments, the information processing layer further includes a game battle information coder, the sample state information further includes sample battle information, and the sample battle information represents a real-time situation of the training game battle in which the first virtual character is involved.

The training module is configured to code the sample battle information by using the game battle information coder in response to that the sample state information is inputted to the action decision-making model, to obtain a game battle state code.

The training module is further configured to determine the action execution reward based on the game battle state code and the sample action execution result.

In some embodiments, the action execution reward includes at least one of an attribute reward, a game battle victory reward, a game battle defeat reward, and a task reward, the game battle victory award being a positive reward, and the game battle defeat reward being a negative reward.

The training module is configured to: determine the game battle victory reward as the action execution reward in response to that the first virtual character achieves a game battle victory; determine the game battle defeat reward as the action execution reward in response to that the first virtual character is defeated in the game battle; determine the attribute reward as the action execution reward in response to that an attribute value of the first virtual character is reduced; and determine the task reward as the action execution reward in response to that a task of the first virtual character succeeds.

In some embodiments, the action execution reward includes an anthropomorphic reward.

The training module is configured to: determine anthropomorphic attribute values of the at least two sample target actions based on sample action execution results obtained after the first virtual character executes the at least two sample target actions in the training game battle; and determine the anthropomorphic reward as the action execution reward in response to that the anthropomorphic attribute values are less than an anthropomorphic attribute threshold.

In some embodiments, the training module is configured to:
determine that the action decision-making model completes an i^{th} round of training in response to that the training game battle ends;
evaluate the action decision-making model completing the i^{th} round of training, to obtain a performance evaluation result;
control the action decision-making model to enter an (i+1)^{th} round of training in response to that the performance evaluation result indicates that the action decision-making model does not reach a training completion criterion; and
determine that the action decision-making model completes training in response to that the performance evaluation result indicates that the action decision-making model reaches the training completion criterion.

In some embodiments, at least one second virtual character exists in the training game battle in which the first virtual character is involved, and the second virtual character executes an action outputted by a second action decision-making model.

The training module is configured to control, in response to that a first action decision-making model corresponding to the first virtual character completes the i^{th} round of training, the second action decision-making model to enter the i^{th} round of training based on the trained first action decision-making model, and store the second action decision-making model completing the i^{th} round of training into an evaluation model pool.

The training module is further configured to: select at least two trained control models from the evaluation model pool; create at least two evaluation game battles, the evaluation game battle including the first virtual character executing an output action of the action decision-making model and a second virtual character executing an output action of the control model; and determine the performance evaluation result according to battle data of the at least two evaluation game battles.

In some embodiments, the training module is configured to: obtain, in response to that an i^{th} round of training of the action decision-making model is completed, battle data of the training game battle performing the i^{th} round of training; determine a game battle index and an anthropomorphic index based on the game battle data of the training game battle for at least two rounds of training, the anthropomorphic index being an actual execution proportion of a particular action in the at least two rounds of training game battles; and determine that the action decision-making model completes training in response to that the game battle index reaches a training completion criterion and the actual execution proportion indicated by the anthropomorphic index matches a target execution proportion, the target execution proportion being a proportion of a real player executing the particular action in a real game battle.

In conclusion, in this embodiment of the present disclosure, an action decision is made based on state information by using an action decision-making model. Thus, a proper target action can be determined according to a current state. The action decision-making model includes n action output heads serially connected. The n action output heads are respectively configured for outputting different target sub-actions. The n action output heads are serially connected based on a dependency relationship between action types, so that during action decision-making, the dependency relationship between different actions can be considered. Additionally, in a process of serially outputting the n target sub-actions, the n target sub-actions are associated temporally and causally, thereby improving appropriateness of the target actions, and improving anthropomorphization of a virtual character.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

Refer to FIG. 19, which shows a schematic structural diagram of a computer device according to an exemplary embodiment of the present disclosure. The computer device may be implemented as a terminal or a server in the foregoing embodiments. Specifically, the computer device 1900 includes a central processing unit (CPU) 1901, a system memory 1904 including a random access memory (RAM) 1902 and a read-only memory (ROM) 1903, and a system bus 1905 connecting the system memory 1904 and the CPU 1901. The computer device 1900 further includes a basic input/output (I/O) system 1906 assisting in information transmission between components in a computer, and a mass storage device 1907 configured to store an operating system 1913, an application 1914, and another program module 1915.

In some embodiments, the basic I/O system 1906 includes a display 1908 configured to display information, and an input device 1909 configured to input information by a user, such as a mouse and a keyboard. The display 1908 and the input device 1909 are both connected to the CPU 1901 by using an I/O controller 1910 connected to the system bus 1905. The basic I/O system 1906 may further include the I/O controller 1910 for receiving and processing inputs from a plurality of other devices such as a keyboard, a mouse, and an electronic stylus. Similarly, the I/O controller 1910 further provides an output to a display screen, a printer, or another type of output device.

The mass storage device 1907 is connected to the CPU 1901 by using a mass storage controller (not shown) connected to the system bus 1905. The mass storage device 1907 and a computer-readable medium associated therewith provide non-volatile storage for the computer device 1900. To be specific, the mass storage device 1907 may include a computer-readable medium (not shown) such as a hard disk or a drive.

Without loss of generality, the computer-readable medium may include computer storage media and communication media. The computer storage medium includes volatile and non-volatile media, and removable and non-removable media that are implemented by any method or technology for storing information such as computer-readable instructions, data structures, program modules, or other data. The computer storage medium includes a RAM, a ROM, a flash memory or another solid storage technology, a compact disc read-only memory (CD-ROM), a digital versatile disc (DVD) or another optical storage, a cassette, a magnetic tape, a disk storage or another magnetic storage device. The computer storage medium is not limited to the foregoing several types. The foregoing system memory 1904 and mass storage device 1907 may be collectively referred to as a memory.

The memory stores one or more programs. The one or more programs are configured to be executed by one or more CPUs 1901. The one or more programs include instructions for implementing the foregoing method. The CPU 1901 executes the one or more programs to implement the method provided in the foregoing method embodiments.

According to embodiments of the present disclosure, the computer device 1900 may further be connected, via a network such as the Internet, to a remote computer on the network and run. To be specific, the computer device 1900 may be connected to a network 1912 through a network interface unit 1911 connected to the system bus 1905, or may be connected to another type of network or a remote computer device system (not shown) through the network interface unit 1911.

The memory further includes one or more programs. The one or more programs are stored in the memory. The one or more programs include operations to be performed by the computer device in the method provided in an embodiment of the present disclosure.

An embodiment of the present disclosure further provides a computer-readable storage medium. The computer-readable storage medium has at least one computer instruction stored therein. The at least one computer instruction is loaded and executed by a processor to implement the virtual character action decision-making method in any of the foregoing embodiments.

An embodiment of the present disclosure provides a computer program product. The computer program product includes a computer instruction. The computer instruction is stored in a computer-readable storage medium. A processor of a computer device reads the computer instruction from the computer-readable storage medium. The processor executes the computer instruction to cause the computer device to perform the virtual character action decision-making method provided in the foregoing aspect.

A person of ordinary skill in the art may understand that all or some of the operations of the methods in the foregoing embodiments may be implemented by a program instructing relevant hardware. The program may be stored in a computer-readable storage medium. The computer-readable storage medium may be a computer-readable storage medium included in the memory in the foregoing embodiment, or may be a computer-readable storage medium that exists alone and is not incorporated into a terminal. The computer-readable storage medium has at least one computer instruction stored therein. The at least one computer instruction is loaded and executed by a processor to implement the virtual character action decision-making method in any of the foregoing method embodiments.

In some embodiments, the computer-readable storage medium may include: a ROM, a RAM, a solid state drive (SSD), an optical disc, and the like. The RAM may include a resistance random access memory (ReRAM) and a dynamic random access memory (DRAM). The sequence numbers of the foregoing embodiments of the present disclosure are merely for description purpose but do not indicate the preference of the embodiments.

All or some of the operations of the foregoing embodiments may be implemented by hardware, or may be implemented by a program instructing relevant hardware. The program may be stored in a computer-readable storage medium. The storage medium may be a ROM, a magnetic disk, an optical disc, or the like.

Information (including but not limited to user equipment information, user personal information, and the like), data (including but not limited to data for analysis, data for storage, data for display, and the like), and signals involved in the present disclosure are all authorized by users or fully authorized by all parties, and collection, use, and processing of relevant data need to comply with relevant laws, regulations, and standards of relevant regions.

Additionally, in the present disclosure, a prompt interface and a pop-up window may be displayed or voice prompt information is outputted before relevant data of a user is collected and during collection of relevant data of the user. The prompt interface, the pop-up window, or the voice prompt information is configured for prompting that relevant data of the user is being collected currently, so that the present disclosure starts the relevant operations of obtaining user-related data only after obtaining a confirm operation performed by the user on the prompt interface or the pop-up window, or otherwise (i.e., when the confirm operation performed by the user on the prompt interface or the pop-up window is not obtained), the relevant operations of obtaining user-related data are ended, i.e., the user-related data is not obtained.

“A plurality of” mentioned in this specification means two or more. The terms “first”, “second”, and the like mentioned in this specification are intended to distinguish similar objects but do not limit a specific order or sequence. In addition, the operation numbers described in this specification merely exemplarily show a possible execution order of the operations. In some other embodiments, the operations may not be performed according to the number order. For example, two operations with different numbers may be performed simultaneously, or two operations with different numbers may be performed according to an order contrary to the order shown in the figure. This is not limited in this embodiment of the present disclosure.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A virtual character action decision-making method, performed by a computer device, the method comprising:
obtaining state information, the state information representing a game battle state of a game battle in which a first virtual character is involved;
inputting the state information to an action decision-making model, to obtain n target sub-actions serially outputted by n action output heads in the action decision-making model, different action output heads corresponding to different action types, the n action output heads being serially connected based on a dependency relationship between the action types, the dependency relationship representing a dependency restriction situation between sub-actions under different action types, and n being an integer greater than 1; and
controlling the first virtual character to execute a target action formed by the n target sub-actions.

2. The method according to claim 1, wherein the action decision-making model comprises an information processing layer, a feature extraction layer, and an action decision-making layer, the action decision-making layer comprising the n action output heads; and
the inputting the state information to an action decision-making model, to obtain n target sub-actions serially outputted by n action output heads in the action decision-making model comprises:
inputting the state information to the action decision-making model, and coding the state information by using the information processing layer, to obtain a state code;
inputting the state code to the feature extraction layer, and extracting a state code feature by using the feature extraction layer, to obtain a fusion feature; and
determining the n target sub-actions by using the n action output heads in the action decision-making layer based on the fusion feature.

3. The method according to claim 2, wherein the determining the n target sub-actions by using the n action output heads in the action decision-making layer based on the fusion feature comprises:
inputting the fusion feature to a first action output head in the action decision-making layer, and determining a first target sub-action from a first action type by using the first action output head; and
inputting embedding coded vectors respectively corresponding to the first target sub-action to an (i−1)^{th} target sub-action and the fusion feature to the action decision-making layer, and determining an i^{th} target sub-action from an i^{th} action type by using an i^{th} action output head in the action decision-making layer, the first target sub-action to the (i−1)^{th} target sub-action being respectively determined by using the first action output head to an (i−1)^{th} action output head, i being less than or equal to n, and i being greater than 1.

4. The method according to claim 3, wherein the action decision-making model further comprises an action masking layer, the action masking layer being connected to the n action output heads in the action decision-making layer, and the action masking layer being configured to mask a sub-action of an action type;
the method further comprises:
masking a sub-action in the i^{th} action type based on the first target sub-action to the (i−1)^{th} target sub-action and a dependency restriction relationship indicated by the dependency restriction situation between sub-actions under different action types, at least two sub-actions having the dependency restriction relationship being not supported to be executed simultaneously; and
the determining an i^{th} target sub-action from an i^{th} action type by using an i^{th} action output head in the action decision-making layer comprises:
determining, by using the i^{th} action output head in the action decision-making layer, the i^{th} target sub-action from sub-actions not masked in the i^{th} action type.

5. The method according to claim 4, wherein the masking a sub-action in the i^{th} action type based on the first target sub-action to the (i−1)^{th} target sub-action and a dependency restriction relationship indicated by the dependency restriction situation between sub-actions under different action types comprises:
masking, in response to that a j^{th} target sub-action is determined and the dependency restriction situation indicates the dependency restriction relationship between the j^{th} target sub-action and at least one first sub-action in the i^{th} action type, the first sub-action in the i^{th} action type, j being less than i;
or,
masking, in response to that an xth target sub-action and a yth target sub-action are determined and the dependency restriction situation indicates the dependency restriction relationship between a combination of the xth target sub-action and the yth target sub-action and at least one second sub-action in the i^{th} action type, the second sub-action in the i^{th} action type, x and y being less than i.

6. The method according to claim 2, wherein the state information comprises character state information of the first virtual character in the game battle and environment sensing information of a virtual environment in which the first virtual character is located, the character state information representing an interaction state between the first virtual character and a second virtual character in the game battle and an interaction state between the first virtual character and the virtual environment in the game battle, the character state information being a one-dimensional vector, the environment sensing information being a two-dimensional image, and the information processing layer comprising a scalar coder and an image coder; and
the inputting the state information to the action decision-making model, and coding the state information by using the information processing layer, to obtain a state code comprises:
inputting the state information to the action decision-making model, and coding the character state information by using the scalar coder in the information processing layer, to obtain a state information coding result;
coding the environment sensing information by using the image coder in the information processing layer, to obtain an environment information coding result; and
concatenating the state information coding result and the environment information coding result by using the information processing layer, to obtain the state code.

7. The method according to claim 6, wherein the action decision-making model further comprises an information filtering layer, the information filtering layer being connected to an output end of the scalar coder, and the information filtering layer being connected to an input end of the action decision-making layer; and
the method further comprises:
filtering the character state information by using the information filtering layer in response to that the character state information is obtained, to obtain filtered character state information, the filtered character state information having a correlation relationship with a first action type corresponding to a first action output head; and
inputting the filtered target character state information to the first action output head.

8. The method according to claim 1, further comprising:
orthogonally decomposing an executable action of the first virtual character, to obtain the n action types, the n action types comprising at least two executable sub-actions, and sub-actions under different action types being supported to be independently controlled.

9. The method according to claim 1, further comprising:
obtaining sample state information, the sample state information representing a game battle state of a training game battle in which the first virtual character is involved; and
training the action decision-making model based on the sample state information in a manner of reinforcement learning.

10. The method according to claim 9, wherein the training the action decision-making model based on the sample state information in a manner of reinforcement learning comprises:
inputting the sample state information to the action decision-making model, to obtain a sample target action outputted by the action decision-making model, the sample target action comprising n sample target sub-actions;
controlling the first virtual character to execute the sample target action, to obtain a sample action execution result of the first virtual character;
determining an action execution reward based on the sample action execution result of the first virtual character; and
updating a model parameter of the action decision-making model based on the action execution reward.

11. The method according to claim 10, wherein the information processing layer further comprises a game battle information coder, the sample state information further comprises sample battle information, and the sample battle information represents a real-time situation of the training game battle in which the first virtual character is involved;
the method further comprises:
coding the sample battle information by using the game battle information coder in response to that the sample state information is inputted to the action decision-making model, to obtain a game battle state code; and
the determining an action execution reward based on the sample action execution result of the first virtual character comprises:
determining the action execution reward based on the game battle state code and the sample action execution result.

12. The method according to claim 10, wherein the action execution reward comprises at least one of an attribute reward, a game battle victory reward, a game battle defeat reward, and a task reward, the game battle victory award being a positive reward, and the game battle defeat reward being a negative reward; and
the determining an action execution reward based on the sample action execution result of the first virtual character comprises:
determining the game battle victory reward as the action execution reward in response to that the first virtual character achieves a game battle victory;
determining the game battle defeat reward as the action execution reward in response to that the first virtual character is defeated in the game battle;
determining the attribute reward as the action execution reward in response to that an attribute value of the first virtual character is reduced; and
determining the task reward as the action execution reward in response to that a task of the first virtual character succeeds.

13. The method according to claim 11, wherein the action execution reward comprises an anthropomorphic reward; and
the determining an action execution reward based on the sample action execution result of the first virtual character comprises:
determining anthropomorphic attribute values of the at least two sample target actions based on sample action execution results obtained after the first virtual character executes the at least two sample target actions in the training game battle; and
determining the anthropomorphic reward as the action execution reward in response to that the anthropomorphic attribute values are less than an anthropomorphic attribute threshold.

14. The method according to claim 9, further comprising:
determining that the action decision-making model completes an i^{th} round of training in response to that the training game battle ends;
evaluating the action decision-making model completing the i^{th} round of training, to obtain a performance evaluation result;
controlling the action decision-making model to enter an (i+1)^{th} round of training in response to that the performance evaluation result indicates that the action decision-making model does not reach a training completion criterion; and
determining that the action decision-making model completes training in response to that the performance evaluation result indicates that the action decision-making model reaches the training completion criterion.

15. The method according to claim 14, wherein at least one second virtual character exists in the training game battle in which the first virtual character is involved, and the second virtual character executes an action outputted by a second action decision-making model;
the method further comprises:
controlling, in response to that a first action decision-making model corresponding to the first virtual character completes the i^{th} round of training, the second action decision-making model to enter the i^{th} round of training based on the trained first action decision-making model, and storing the second action decision-making model completing the i^{th} round of training into an evaluation model pool; and
the evaluating the action decision-making model completing the i^{th} round of training, to obtain a performance evaluation result comprises:
selecting at least two trained control models from the evaluation model pool;
creating at least two evaluation game battles, the evaluation game battle comprising the first virtual character executing an output action of the action decision-making model and a second virtual character executing an output action of the control model; and
determining the performance evaluation result according to battle data of the at least two evaluation game battles.

16. The method according to claim 9, further comprising:
obtaining, in response to that an i^{th} round of training of the action decision-making model is completed, battle data of the training game battle performing the i^{th} round of training;
determining a game battle index and an anthropomorphic index based on the game battle data of the training game battle for at least two rounds of training, the anthropomorphic index being an actual execution proportion of a particular action in the at least two rounds of training game battles; and
determining that the action decision-making model completes training in response to that the game battle index reaches a training completion criterion and the actual execution proportion indicated by the anthropomorphic index matches a target execution proportion, the target execution proportion being a proportion of a real player executing the particular action in a real game battle.

17. A virtual character action decision-making apparatus, comprising:
a processor and a memory, the memory having at least one computer instruction stored therein, and the at least one computer instruction being loaded and executed by the processor to implement:
obtaining state information, the state information representing a game battle state of a game battle in which a first virtual character is involved;
inputting the state information to an action decision-making model, to obtain n target sub-actions serially outputted by n action output heads in the action decision-making model, different action output heads corresponding to different action types, the n action output heads being serially connected based on a dependency relationship between the action types, the dependency relationship representing a dependency restriction situation between sub-actions under different action types, and n being an integer greater than 1; and
controlling the first virtual character to execute a target action formed by the n target sub-actions.

18. The apparatus according to claim 17, wherein the action decision-making model comprises an information processing layer, a feature extraction layer, and an action decision-making layer, the action decision-making layer comprising the n action output heads; and
the inputting the state information to an action decision-making model, to obtain n target sub-actions serially outputted by n action output heads in the action decision-making model comprises:
inputting the state information to the action decision-making model, and coding the state information by using the information processing layer, to obtain a state code;
inputting the state code to the feature extraction layer, and extracting a state code feature by using the feature extraction layer, to obtain a fusion feature; and
determining the n target sub-actions by using the n action output heads in the action decision-making layer based on the fusion feature.

19. The apparatus according to claim 18, wherein the determining the n target sub-actions by using the n action output heads in the action decision-making layer based on the fusion feature comprises:
inputting the fusion feature to a first action output head in the action decision-making layer, and determining a first target sub-action from a first action type by using the first action output head; and
inputting embedding coded vectors respectively corresponding to the first target sub-action to an (i−1)^{th} target sub-action and the fusion feature to the action decision-making layer, and determining an i^{th} target sub-action from an i^{th} action type by using an i^{th} action output head in the action decision-making layer, the first target sub-action to the (i−1)^{th} target sub-action being respectively determined by using the first action output head to an (i−1)^{th} action output head, i being less than or equal to n, and i being greater than 1.

20. A non-transitory computer-readable storage medium, having at least one computer instruction stored therein, the at least one computer instruction being loaded and executed by a processor to implement:
obtaining state information, the state information representing a game battle state of a game battle in which a first virtual character is involved;
inputting the state information to an action decision-making model, to obtain n target sub-actions serially outputted by n action output heads in the action decision-making model, different action output heads corresponding to different action types, the n action output heads being serially connected based on a dependency relationship between the action types, the dependency relationship representing a dependency restriction situation between sub-actions under different action types, and n being an integer greater than 1; and
controlling the first virtual character to execute a target action formed by the n target sub-actions.
